(19) United States
(12) Patent Application Publication
(10) Pub. No.: US 2012/0112700 A1
(43) Pub. Date: May 10, 2012

(54) CIRCUIT FOR COUNTING NUMBER OF CYCLES, BATTERY PACK AND BATTERY SYSTEM

(76) Inventors: Tsuyoshi Morimoto, Osaka (JP); Toshiyuki Nakatsuji, Hyogo (JP)

(21) Appl. No.: 13/383,129

(22) PCT Filed: Jun. 15, 2010
(86) PCT No.: PCT/JP2010/003970

§ 371 Date: Jan. 9, 2012

(30) Foreign Application Priority Data
Jul. 10, 2009 (JP) 2009-163624

(51) Int. Cl. H02J 7/00

(52) U.S. Cl. 320/132

(57) ABSTRACT

A circuit for counting a number of cycles, including: a current detecting portion that detects a current value of a current flowing to a secondary battery; a current integrating portion that calculates, as an integrated electric quantity, an integrated value of the current value detected by the current detecting portion; a cycle electric quantity setting portion that successively sets a cycle electric quantity corresponding to one cycle of a cycle life of the secondary battery; and a cycle counting portion that counts a number of cycles of the cycle life, wherein the cycle counting portion adds one to the last counted number of cycles when an increment of the integrated electric quantity calculated by the current integrating portion after the number of cycles is counted last time reaches a last set cycle electric quantity, and the cycle electric quantity setting portion decreases a predetermined decrement from the last set cycle electric quantity to set a new cycle electric quantity when the increment of the integrated electric quantity calculated by the current integrating portion after the number of cycles is counted last time reaches the last set cycle electric quantity.

### TECHNICAL FIELD

The present invention relates to a circuit for counting a number of cycles for counting a charging/discharging the number of cycles of a secondary battery, a battery pack including the same, and a battery system including the same.

### BACKGROUND ART

A secondary battery is deteriorated with a charging/discharging cycle for repeating a charging/discharging operation irrespective of a type of the secondary battery, for example, a lithium ion secondary battery, a nickel-hydrogen secondary battery, a lead storage battery or the like. For this reason, the number of cycles in a repetition of a charging/discharging cycle for charging/discharging a secondary battery between a discharge cut-off state (SOC (State Of Charge) is 0%) and a full charge state (SOC is 100%) until a battery capacity reaches a predetermined life end-stage capacity is referred to as a cycle life, and a life of the secondary battery is represented by the cycle life.

For example, there is known the technique in which a circuit for counting a charging/discharging cycle number of a secondary battery is provided in a battery pack and it is determined that the secondary battery runs down when the counted charging/discharging cycle number is equal to or more than a cycle life (for example, see Patent Document 1).

In order to determine a cycle life, it is necessary to count, as a single cycle in the cycle life of the secondary battery, a charging/discharging cycle combining a charge to be carried out from a discharge cut-off state to a full charging state and a discharge to be carried out from the full charging state to the discharge cut-off state in the secondary battery. In the case in which the secondary battery is actually used, however, the charge is not always carried out until the full charging state is brought and the discharge is not always carried out until the discharge cut-off state is brought.

For example, a user carries out the charge before the secondary battery is brought into the discharge cut-off state or stops the charge to use (discharge) the secondary battery before the full charging state is brought, in some cases. Consequently, the secondary battery is not charged into the full charging state or the discharge is not carried out until the discharge cut-off state is brought. For this reason, there is a disadvantage that a necessary charging/discharging cycle number for determining a cycle life cannot be counted accurately.

Moreover, there is known a power supply system in which a power generator to be driven by a natural energy such as a wind power and a water power or an artificial power such as an internal combustion engine and the like or a solar cell is combined with a secondary battery to store an excessive power in the secondary battery and to supply the power from the secondary battery to a load device when required, thereby enhancing an energy efficiency.

Referring to a power supply system to be used in a Hybrid Electric Vehicle (HEV) utilizing an engine and a motor, moreover, a power generator is driven through an excessive engine power to charge a secondary battery in the case in which a power from an engine is great for a necessary power for running. Moreover, the HEV charges the secondary battery by utilizing a motor as the power generator in braking or deceleration of the vehicle.

In such a power supply system, if the secondary battery is brought into a full charging state, an excessive power cannot be charged so that a loss occurs. In order to efficiently charge the excessive power into the secondary battery, therefore, a charging control is carried out in such a manner that the SOC of the secondary battery does not reach 100%. In order to enable a load device to be driven when necessary, moreover, the charging control is also carried out in such a manner that the SOC does not reach 0(zero) %. More specifically, in the power supply system, the charging control is carried out in such a manner that the SOC of the secondary battery makes a transition within a range of 20% to 80%.

In the power supply system described above, consequently, the secondary battery is not charged into the full charging state and is not discharged into the discharge cut-off state. For this reason, there is a disadvantage that it is impossible to carry out an operation for counting charging/discharging cycles which is required for determining a cycle life. Moreover, there is a disadvantage that it is impossible to carry out the operation for counting charging/discharging cycles which is required for determining the cycle life depending on a way for using the secondary battery by a user.

Patent Document 1: Japanese Patent Application Laid-Open No. 2008-277136

### SUMMARY OF THE INVENTION

It is an object of the present invention to provide a circuit for counting number of cycles capable of enhancing precision in counting of the number of cycles in a cycle life also in the case in which a secondary battery is not charged into a full charging state or is not discharged into a discharge cut-off state, a battery pack including the same, and a battery system including the same.

A circuit for counting a number of cycles according to an aspect of the present invention includes: a current detecting portion that detects a current value of a current flowing to a secondary battery; a current integrating portion that calculates, as an integrated electric quantity, an integrated value of the current value detected by the current detecting portion; a cycle electric quantity setting portion that successively sets a cycle electric quantity corresponding to one cycle of a cycle life of the secondary battery; and a cycle counting portion that counts a number of cycles of the cycle life, wherein the cycle counting portion adds one to the last counted number of cycles when an increment of the integrated electric quantity calculated by the current integrating portion after the number of cycles is counted last time reaches a last set cycle electric quantity, and the cycle electric quantity setting portion decreases a predetermined decrement from the last set cycle electric quantity to set a new cycle electric quantity when the increment of the integrated electric quantity calculated by the current integrating portion after the number of cycles is counted last time reaches the last set cycle electric quantity.

Moreover, a circuit for counting a number of cycles according to an aspect of the present invention includes: a cycle counting portion that counts a number of cycles in a cycle life of a secondary battery; a charging control portion that controls a charge of the secondary battery in such a manner that a terminal voltage of the secondary battery does not exceed a predetermined set voltage; a deterioration degree acquiring portion that obtains a deterioration degree representing an extent of a deterioration in the secondary battery based on the number of cycles counted by the cycle counting portion; and a charging voltage setting portion that reduces the set voltage in accordance with an increase in the deterioration degree acquired by the deterioration degree acquiring portion, wherein the deterioration degree acquiring portion includes: a cycle deterioration value calculating portion that calculates a cycle deterioration value representing an extent of a cycle deterioration by integrating predetermined cycle addition value every time the number of cycles is updated by the cycle counting portion; a cycle addition value setting portion that sets the cycle addition value to be decreased in accordance with a reduction in the set voltage which is set by the charging voltage setting portion; and an acquiring portion that acquires the deterioration degree based on the cycle deterioration value calculated by the cycle deterioration value calculating portion.

Moreover, a battery pack according to an aspect of the present invention includes the circuit for counting a number of cycles described above and the secondary battery.

### BRIEF DESCRIPTION OF THE DRAWINGS

FIG. 1 is a block diagram showing an example of structures of a battery pack including a circuit for counting a number of cycles, and a battery system according to an embodiment of the present invention.

FIG. 2 is a graph for describing an example of an operation of the battery system shown in FIG. 1.

FIG. 3 is a graph showing a variant of the operation shown in FIG. 2.

FIG. 4 is a block diagram showing a variant of the circuit for counting a number of cycles illustrated in FIG. 1.

FIG. 5 is a graph for describing an example of an operation of a battery system shown in FIG. 4.

FIG. 6 is a block diagram showing a variant of the circuit for counting a number of cycles illustrated in FIG. 4.

FIG. 7 is a block diagram showing an example of structures of a battery pack including a circuit for counting a number of cycles, and a battery system according to a second embodiment of the present invention.

FIG. 8 is a block diagram showing an example of a structure of a control portion illustrated in FIG. 7.

FIG. 9 is a chart for describing an example of an operation of a charging control portion illustrated in FIG. 8.

FIG. 10 is an explanatory chart showing an example of an operation of the battery system illustrated in FIG. 7.

FIG. 11 is an explanatory chart showing an example of an operation according to a variant of the battery system illustrated in FIG. 7.

### BEST MODE FOR CARRYING OUT THE INVENTION

Embodiments according to an aspect of the present invention will be described with reference to the drawings. Structures having the same reference numerals in each drawing are identical and description thereof will be omitted.

### First Embodiment

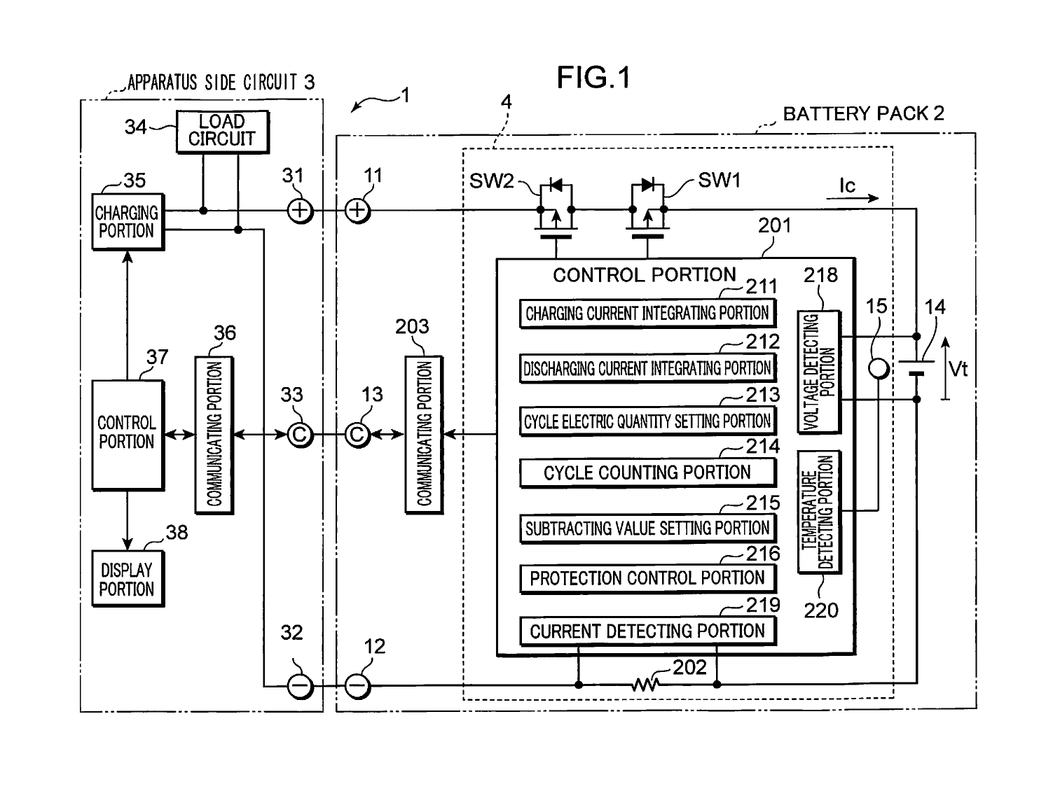

FIG. 1 is a block diagram showing an example of structures of a battery pack 2 and a battery system 1 including a circuit for counting number of cycles 4 according to a first embodiment of the present invention. The battery system 1 shown in FIG. 1 is constituted by a combination of the battery pack 2 and an apparatus side circuit 3.

The battery system 1 is an apparatus system provided with a battery, for example, an electronic apparatus such as a portable personal computer, a digital camera or a portable telephone, a vehicle such as an electric car or a hybrid car, or the like. The apparatus side circuit 3 is a body part of the apparatus system provided with a battery, for example. A load circuit 34 is operated through a supply of a power from the battery pack 2 in the apparatus system provided with a battery.

The battery pack 2 includes the circuit for counting number of cycles 4, connecting terminals 11, 12 and 13, a communicating portion 203 (a notifying portion), and a secondary battery 14. Moreover, the circuit for counting number of cycles 4 includes a control portion 201, a current detecting resistor 202, a temperature sensor 15, a discharging switching element SW1, and a charging switching element SW2.

The battery system 1 is not always restricted to be constituted separably into the battery pack 2 and the apparatus side circuit 3 but a single circuit for counting number of cycles 4 may be constituted by the whole battery system 1. Moreover, the circuit for counting number of cycles 4 may be shared by the battery pack 2 and the apparatus side circuit 3. Furthermore, the secondary battery 14 does not need to be a battery pack. In addition, the circuit for counting number of cycles 4 may be constituted as an in-vehicle ECU (Electric Control Unit), for example.

The apparatus side circuit 3 includes connecting terminals 31, 32 and 33, the load circuit 34, a charging portion 35, a communicating portion 36, a control portion 37, and a display portion 38 (a notifying portion). The charging portion 35 is connected to the connecting terminals 31 and 32 for supplying a power, and the communicating portion 36 is connected to the connecting terminal 33.

When the battery pack 2 is attached to the apparatus side circuit 3, moreover, the connecting terminals 11, 12 and 13 of the battery pack 2 are connected to the connecting terminals 31, 32 and 33 of the apparatus side circuit 3, respectively.

The communicating portions 203 and 36 are communication interface circuits which are constituted to enable a data transmission/receipt to/from each other through the connecting terminals 13 and 33.

The display portion 38 is a display device constituted by using a liquid crystal display unit, an LED or the like, for example.

The charging portion 35 is a power supply circuit for supplying a current and a voltage corresponding to a control signal sent from the control portion 37 to the battery pack 2 through the connecting terminals 31 and 32. The charging portion 35 may be a power supply circuit for generating a charging current of the battery pack 2 from a commercial supply voltage, for example. Moreover, the charging portion 35 may be a power generator for generating a power based on a natural energy such as a sunlight, a wind power or a water power or a power generator for generating a power through a power of an internal combustion engine, or the like.

The control portion 37 is a control circuit constituted by using a microcomputer, for example. When a request instruction transmitted from the control portion 201 in the battery pack 2 through the communicating portion 203 is received by the communicating portion 36, the control portion 37 controls the charging portion 35 in response to the request instruction received by the communicating portion 36. Consequently, a current and a voltage corresponding to the request instruction transmitted from the battery pack 2 is output from the charging portion 35 to the connecting terminals 11 and 12.

When information about a life of the secondary battery 14 depending on the number of cycles is received from the control portion 201 to the communicating portion 36, moreover, the control portion 37 causes the display portion 38 to display the information.

The control portion 37 is not restricted to an example in which the charging portion 35 is controlled in accordance with the request instruction received by the communicating portion 36 but may control a charging current to be supplied from the charging portion 35 to the secondary battery 14 in order to maintain the SOC of the secondary battery 14 within a range of 20% to 80%, for example.

In the battery pack 2, the connecting terminal 11 is connected to a positive electrode of the secondary battery 14 through the charging switching element SW2 and the discharging switching element SW1. For the discharging switching element SW1 and the charging switching element SW2, for example, a p-channel FET (Field Effect Transistor) is used.

The discharging switching element SW1 and the charging switching element SW2 have parasitic diodes, respectively. The parasitic diode of the charging switching element SW2 is disposed in such an orientation that a direction in which the discharging current of the secondary battery 14 flows (a direction from the positive electrode of the secondary battery 14 toward the connecting terminal 11) is identical to a forward direction of the parasitic diode. Consequently, the charging switching element SW2 cuts off only a current in the charging direction of the secondary battery 14 (a direction from the connecting terminal 11 toward the positive electrode of the secondary battery 14) when it is turned OFF.

Moreover, the parasitic diode of the discharging switching element SW1 is disposed in such an orientation that a direction in which the charging current of the secondary battery 14 flows is identical to a forward direction of the parasitic diode. Consequently, the discharging switching element SW1 cuts off only a current in the discharging direction of the secondary battery 14 when it is turned OFF.

Moreover, the connecting terminal 12 is connected to a negative electrode of the secondary battery 14 through the current detecting resistor 202. There is constituted a current path from the connecting terminal 11 to the connecting terminal 12 through the charging switching element SW2, the discharging switching element SW1, the secondary battery 14 and the current detecting resistor 202.

It is sufficient that the connecting terminals 11, 12, 13, 31, 32 and 33 electrically connect the battery pack 2 to the apparatus side circuit 3, and they may be electrodes, connectors, terminal blocks or the like or may be wiring patterns such as lands or pads, for example.

The current detecting resistor 202 converts the charging current and the discharging current of the secondary battery 14 into voltage values.

The secondary battery 14 may be a cell or assembled cells in which a plurality of secondary batteries is connected in series, for example, assembled cells in which a plurality of secondary batteries is connected in parallel, for example, or assembled cells in which serial and parallel connections are combined. For the secondary battery 14, there are used various secondary batteries, for example, a lithium ion secondary battery, a nickel-metal hydride secondary battery and the like.

The temperature sensor 15 is constituted by using a thermistor, a thermocouple or the like, for example. The temperature sensor 15 is provided in close contact with the secondary battery 14 or in the vicinity of the secondary battery 14, for example, and detects a temperature of the secondary battery 14 and outputs a voltage signal indicative of the temperature value to the control portion 201.

The control portion 201 includes a CPU (Central Processing Unit) for executing predetermined arithmetic processing, a ROM (Read Only Memory) storing a predetermined control program, a RAM (Random Access Memory) for temporarily storing data, an analog-to-digital converting circuit, their peripheral circuits, and the like, for example.

The control portion 201 executes the control program stored in the ROM, thereby functioning as a charging current integrating portion 211, a discharging current integrating portion 212, a cycle electric quantity setting portion 213, a cycle counting portion 214, a subtracting value setting portion 215 (a decrement setting portion), a protection control portion 216, a voltage detecting portion 218, a current detecting portion 219, and a temperature detecting portion 220.

The voltage detecting portion 218, the current detecting portion 219 and the temperature detecting portion 220 are constituted by using an analog-to-digital converting circuit, for example.

The voltage detecting portion 218 detects a terminal voltage Vt of the secondary battery 14. The temperature detecting portion 220 acquires data indicative of the temperature of the secondary battery 14 based on a voltage signal output from the temperature sensor 15.

The current detecting portion 219 detects a voltage Vr between both terminals of the current detecting resistor 202, and divides the voltage Vr by a resistance value R of the current detecting resistor 202, thereby acquiring a charging/discharging current value Ic in the secondary battery 14. Referring to the charging/discharging current value Ic, moreover, the current detecting portion 219 expresses the current value in such a direction as to charge the secondary battery 14 in a positive value and expresses the current value in such a direction as to discharge the secondary battery 14 in a negative value, for example.

The charging current integrating portion 211 integrates only the positive current value detected by the current detecting portion 219 every unit time, thereby integrating only the charging current of the secondary battery to calculate a charge integrated electric quantity Qc, for example.

The discharging current integrating portion 212 integrates an absolute value of only the negative current value detected by the current detecting portion 219 every unit time, thereby integrating only the discharging current of the secondary battery to calculate a discharge integrated electric quantity Qd, for example.

The cycle electric quantity setting portion 213 sets, as a cycle electric quantity Qcyc, a charging electric quantity corresponding to one cycle in the cycle life of the secondary battery 14. More specifically, the cycle electric quantity setting portion 213 first sets, as an initial value of the cycle electric quantity Qcyc, a full charging capacity value Qf in an initial condition of the secondary battery 14.

The cycle electric quantity setting portion 213 subtracts a subtracting value dQ (a decrement) set by the subtracting value setting portion 215 from the cycle electric quantity Qcyc set currently to set a new cycle electric quantity Qcyc every time an increment of the discharge integrated electric quantity Qd calculated by the discharging current integrating portion 212 after a start of a first use of the battery pack 2 and an increment of the discharge integrated electric quantity Qd after the discharge integrated electric quantity Qd once reaches the cycle electric quantity Qcyc since a last cycle electric quantity Qcyc is reached reach the cycle electric quantity Qcyc which is currently set.

The cycle counting portion 214 adds one to the number of cycles Ncyc every time an increment of the charge integrated electric quantity Qc calculated by the charging current integrating portion 211 after a start of a first use of the battery pack 2 and an increment of the charge integrated electric quantity Qc after the charge integrated electric quantity Qc once reaches the cycle electric quantity Qcyc since the last cycle electric quantity Qcyc of the charge integrated electric quantity Qc is reached reach the cycle electric quantity Qcyc which is set by the cycle electric quantity setting portion 213.

The charging current integrating portion 211 may reset the charge integrated electric quantity Qc into zero to integrate the charge integrated electric quantity Qc again every time the charge integrated electric quantity Qc reaches the cycle electric quantity Qcyc. In this case, the increment of the charge integrated electric quantity Qc is equal to the charge integrated electric quantity Qc itself.

Moreover, the discharging current integrating portion 212 may reset the discharge integrated electric quantity Qd into zero to integrate the discharge integrated electric quantity Qd again every time the discharge integrated electric quantity Qd reaches the cycle electric quantity Qcyc. In this case, the increment of the discharge integrated electric quantity Qd is equal to the discharge integrated electric quantity Qd itself.

The subtracting value setting portion 215 sets the subtracting value dQ to increase the subtracting value dQ when a temperature t of the secondary battery 14 detected by the temperature detecting portion 220 deteriorates the secondary battery 14 easily depending on the temperature t. The subtracting value setting portion 215 may always update the subtracting value dQ depending on the temperature t of the secondary battery 14, for example, and may set the subtracting value dQ depending on the temperature t immediately before a new cycle electric quantity Qcyc is set by the cycle electric quantity setting portion 213 every time the increment of the discharge integrated electric quantity Qd reaches the cycle electric quantity Qcyc.

Every time the secondary battery repeats the charging/discharging cycle, a full charging capacity thereof is decreased due to deterioration. Moreover, the secondary battery generally has a suitable temperature range for the charge/discharge. Within the suitable temperature range, the deterioration is rarely caused by the execution of the charge/discharge and a decrease in the battery capacity is also lessened. On the other hand, when the charge/discharge is performed outside the suitable temperature range, the farther away from the suitable temperature range, the more the deterioration caused by the charge/discharge is increased, resulting in an increase in the decrease in the battery capacity.

Accordingly, the decrement of the full charging capacity in a single charging/discharging cycle (SOC: 0%→100%→0%) is experimentally obtained corresponding to the temperature of the secondary battery and is set to be the subtracting value dQ, and a data table is created by a correspondence of the subtracting value dQ and the temperature, for example. The data table is prestored in the ROM, for example.

The subtracting value setting portion 215 sets the subtracting value dQ corresponding to the temperature t of the secondary battery 14 with reference to the data table thus obtained, thereby setting the subtracting value dQ to be a small value if the temperature t is within the suitable temperature range and setting the subtracting value dQ to be a greater value when the temperature t deviates from the suitable temperature range farther if the temperature t is out of the suitable temperature range, that is, the temperature t is apt to deteriorate the secondary battery 14.

For example, a suitable temperature range for the charge/discharge of a lithium ion secondary battery is equal to or higher than 10° C. and is equal to or lower than 45° C. Therefore, the subtracting value setting portion 215 sets the subtracting value dQ to be a greater value, when the temperature t of the secondary battery 14 is lower away from 10° C., which is a lower limit of the suitable temperature range, and sets the subtracting value dQ to be a greater value when the temperature t is higher away from 45° C., which is an upper limit of the suitable temperature range.

Based on an optimum temperature of 25° C. which is the most appropriate for the charge/discharge of the lithium ion secondary battery, for example, in place of the upper and lower limits of the suitable temperature range, the subtracting value dQ may be set to be a greater value when a difference between the optimum temperature and the temperature t is greater.

Moreover, the subtracting value setting portion 215 may set the decrement of the full charging capacity in the single charging/discharging cycle as a decrease rate expressed in a ratio (1≧decrease rate>0). In this case, the subtracting value setting portion 215 may set the decrease rate to reduce more when a difference between the upper and lower limits of the suitable temperature range or the optimum temperature and the temperature t is greater. In this case, the cycle electric quantity setting portion 213 and cycle electric quantity setting portions 213a and 213b which will be described below may set a new cycle electric quantity Qcyc by multiplying the cycle electric quantity Qcyc set currently by the decrease rate set by the decrement setting portion instead of subtracting the subtracting value dQ from the cycle electric quantity Qcyc set currently.

When the number of cycles Ncyc counted by the cycle counting portion 214 is equal to or greater than a cycle life NL of the secondary battery 14, the protection control portion 216 determines that the secondary battery 14 runs down, and turns OFF the discharging switching element SW1 and the charging switching element SW2 to prohibit the charge/discharge of the secondary battery 14.

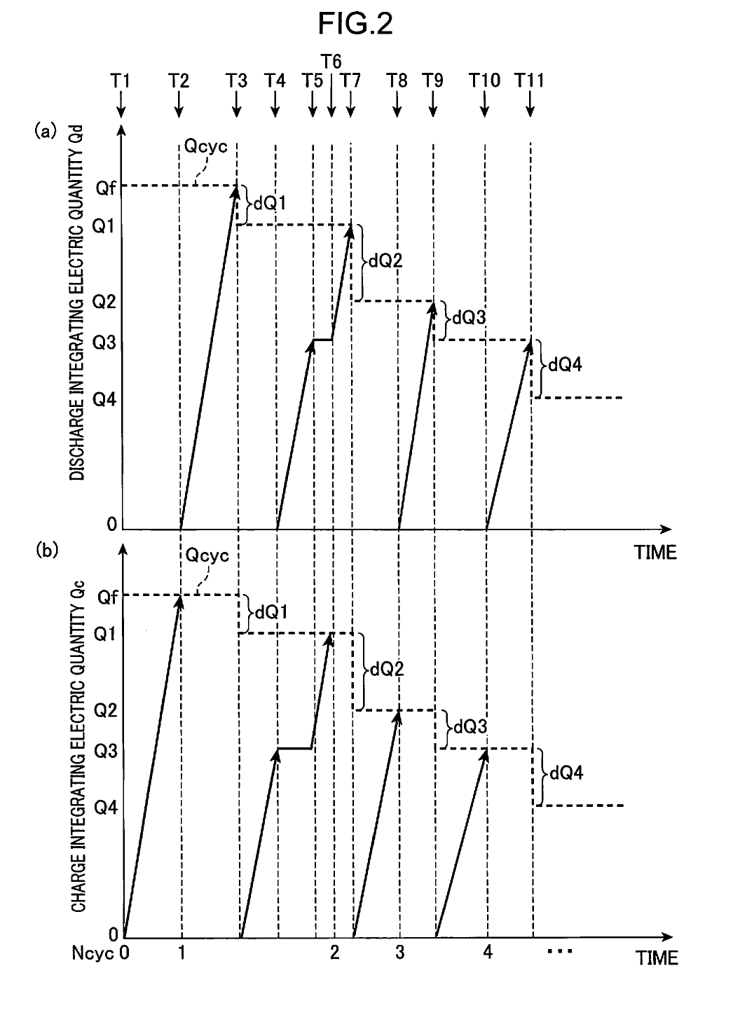

Next, description will be given to an operation of the battery system 1 having the structure described above. FIG. 2 is a graph for describing an example of the operation of the battery system 1 shown in FIG. 1. FIG. 2(a) shows, in a solid-line arrow, a change in the discharge integrated electric quantity Qd integrated by the discharging current integrating portion 212 and shows the cycle electric quantity Qcyc in a broken line. FIG. 2(b) shows, in a solid-line arrow, a change in the charge integrated electric quantity Qc integrated by the charging current integrating portion 211 and shows the cycle electric quantity Qcyc in a broken line. Moreover, an axis of abscissa indicates a passage of time, and predetermined timings T1 to T11 are shown in an upper part of the graph and a value of the number of cycles Ncyc is described in a lower part of the graph.

FIG. 2 shows an example in which the charging current integrating portion 211 resets the charge integrated electric quantity Qc into zero, thereby integrating the charge integrated electric quantity Qc again every time the charge integrated electric quantity Qc reaches the cycle electric quantity Qcyc, and the discharging current integrating portion 212 resets the discharge integrated electric quantity Qd into zero, thereby integrating the discharge integrated electric quantity Qd again every time the discharge integrated electric quantity Qd reaches the cycle electric quantity Qcyc.

First of all, in the initial timing T1, both the charge integrated electric quantity Qc and the discharge integrated electric quantity Qd are zero, and the number of cycles Ncyc is also set to be zero. Moreover, the full charging capacity value Qf is set as an initial value of the cycle electric quantity Qcyc.

First of all, description will be given to the case in which the secondary battery 14 is charged into a full charging state (SOC: 100%) and is discharged to obtain SOC of 0% in the timings T1 to T3. When a charging current is supplied from the charging portion 35 so that the secondary battery 14 is charged into the full charging state, the charging current is integrated by the charging current integrating portion 211 so that the charge integrated electric quantity Qc is increased.

When the charge integrated electric quantity Qc is equal to or larger than the full charging capacity value Qf, that is, the cycle electric quantity Qcyc (the timing T2), then, the cycle counting portion 214 adds one to the number of cycles Ncyc and transmits the number of cycles Ncyc to the communicating portion 36 of the apparatus side circuit 3 through the communicating portion 203.

Consequently, the number of cycles Ncyc received by the communicating portion 36 is acquired by the control portion 37, and the control portion 37 displays the number of cycles Ncyc (=1) by means of the display portion 38. In this case, it is indicated that the life of the secondary battery 14 is shorter as the number of cycles Ncyc is greater. Therefore, the number of cycles Ncyc is used as information about the life of the secondary battery 14.

Subsequently, the number of cycles Ncyc is transmitted to the communicating portion 36 of the apparatus side circuit 3 through the communicating portion 203 and is displayed by the display portion 38 every time the number of cycles Ncyc is counted by the cycle counting portion 214.

The cycle counting portion 214 may have such a structure as to cause the display portion 38 to give, as a residual life, a value obtained by subtracting the number of cycles Ncyc from the cycle life of the secondary battery 14, for example, to cause the display portion 38 to give a ratio (%) of the number of cycles Ncyc to the cycle life of the secondary battery 14 as information about the life of the secondary battery 14, or to give the information about the life of the secondary battery 14 by various methods based on the number of cycles Ncyc.

When the secondary battery 14 is discharged in the timings T2 to T3, next, the discharging current is integrated by the discharging current integrating portion 212 so that the discharge integrated electric quantity Qd is increased. When the discharge integrated electric quantity Qd reaches the full charging capacity value Qf, that is, the cycle electric quantity Qcyc (the timing T3), then, the subtracting value dQ is set to be, for example, the subtracting value dQ1 depending on the temperature t of the secondary battery 14 by the subtracting value setting portion 215, and furthermore, the subtracting value dQ1 is subtracted from the current cycle electric quantity Qcyc (=the full charging capacity value Qf) by the cycle electric quantity setting portion 213 and a capacity value Q1 thus calculated is set to be a new cycle electric quantity Qcyc.

In other words, the cycle electric quantity Qcyc is decreased depending on the decrease in the battery capacity of the secondary battery 14 through the charging/discharging cycle in the timings T1 to T3. In a next charging/discharging cycle, therefore, it is possible to enhance precision in the counting of the number of cycles Ncyc based on the cycle electric quantity Qcyc.

One cycle in the cycle life is constituted by the charging cycle of the cycle electric quantity Qcyc in the timings T1 to T2 and the discharging cycle of the cycle electric quantity Qcyc in the timings T2 to T3, and one is added to the number of cycles Ncyc.

If the addition of the number of cycles Ncyc through the cycle counting portion 214 and the update of the cycle electric quantity Qcyc through the cycle electric quantity setting portion 213 are executed in the same timing (the timing T2), the set value of the cycle electric quantity Qcyc is decreased into the capacity value Q1 which is smaller than the full charging capacity value Qf by the subtracting value dQ1 in the timing T2.

One cycle in the cycle life of the secondary battery is obtained by combining the charging cycle and the discharging cycle. When the set value of the cycle electric quantity Qcyc becomes the capacity value Q1 in the timing T2, the charge integrated electric quantity Qc between the timings T1 and T2 is set to be one charging cycle with the full charging capacity value Qf, while the discharge integrated electric quantity Qd between the timings T2 and T3 is set to be one discharging cycle with the capacity value Q1. Therefore, a difference is made between the charging cycle and the discharging cycle so that an error is made in the counting of one cycle in the cycle life.

In the circuit for counting number of cycles 4 shown in FIG. 1, however, the cycle counting portion 214 adds the number of cycles Ncyc based on the charge integrated electric quantity Qc obtained by the charging current integrating portion 211, and the cycle electric quantity setting portion 213 sets and updates the cycle electric quantity Qcyc based on the discharge integrated electric quantity Qd obtained by the discharging current integrating portion 212. Therefore, capacity values to be used for a determination in one cycle are equal to each other in the charging cycle and the discharging cycle. As compared with the case in which the addition of the number of cycles Ncyc and the update of the cycle electric quantity Qcyc are executed in the same timing, consequently, precision in the counting of the number of cycles Ncyc can be enhanced more greatly.

Next, description will be given to the operation of the circuit for counting number of cycles 4 in the case in which the charge is stopped to use (discharge) the secondary battery 14 before it is fully charged, and the charge is carried out before the secondary battery 14 is brought into the discharge cut-off state in the timings T3 to T7.

First of all, in the timings T3 to T4, a charging current is supplied from the charging portion 35 so that the secondary battery 14 is charged, and the charging current is integrated by the charging current integrating portion 211 so that the charge integrated electric quantity Qc is increased. When the load circuit 34 starts an operation so that the secondary battery 14 is switched from charging into discharging in the timing T4, for example, the discharging current is integrated by the discharging current integrating portion 212 so that the discharge integrated electric quantity Qd is increased.

Furthermore, when the load circuit 34 stops the operation so that the charging current is supplied from the charging portion 35 and the secondary battery 14 is switched from the discharging to the charging in the timing T5, for example, the charging current is integrated by the charging current integrating portion 211 so that the charge integrated electric quantity Qc is increased. When the charge integrated electric quantity Qc is equal to or larger than the capacity Q1, that is, the cycle electric quantity Qcyc (the timing T6), then, the cycle counting portion 214 adds one to the number of cycles Ncyc so that the number of cycles Ncyc of two is obtained.

Subsequently, when the load circuit 34 starts the operation so that the secondary battery 14 is switched from the charging to the discharging in the timing T6, for example, the discharging current is integrated by the discharging current integrating portion 212 so that the discharge integrated electric quantity Qd is increased. When the discharge integrated electric quantity Qd is equal to or larger than the capacity Q1, that is, the cycle electric quantity Qcyc (the timing T7), then, the subtracting value dQ is set to be the subtracting value dQ2, for example, depending on the temperature t of the secondary battery 14 by the subtracting value setting portion 215.

In the timing T7, moreover, the subtracting value dQ2 is subtracted from the current cycle electric quantity Qcyc (=the capacity value Q1) by the cycle electric quantity setting portion 213, and a capacity value Q2 thus obtained is newly set to be the cycle electric quantity Qcyc.

In the case in which the temperature t detected by the temperature detecting portion 220 in the timing T3 is 25° C. within the suitable temperature range, for example, and the temperature t detected by the temperature detecting portion 220 in the timing T7 is 55° C. exceeding the upper limit of the suitable temperature range, for example, the secondary battery 14 is deteriorated more easily at the temperature in the timing T7 than that in the timing T3.

For this reason, the subtracting value dQ2 set in the timing T7 is set to be greater than the subtracting value dQ1 set in the timing T3 by the subtracting value setting portion 215. Consequently, the cycle electric quantity Qcyc is reflected by an extent of the deterioration in the secondary battery 14 which is influenced by the temperature t. Therefore, the precision in the decision for one cycle based on the cycle electric quantity Qcyc can be enhanced. As a result, precision in the calculation of the number of cycles Ncyc in a next cycle can be improved.

In the timings T3 to T7, moreover, the secondary battery 14 is discharged before it is charged into the full charging state and is charged before it is discharged into the discharge cut-off state. When the charge/discharge is carried out, it is impossible to accurately carry out an operation for counting charging/discharging cycles which is required for determining a cycle life in the background art described above.

According to the circuit for counting number of cycles 4 described in FIG. 1, however, when the charge integrated electric quantity Qc reaches the cycle electric quantity Qcyc by using the cycle electric quantity Qcyc corresponding to the full charging capacity reflecting the deterioration in the secondary battery 14 as shown in the timings T3 to T7, the number of cycles Ncyc can be counted. Even if the charge into the full charging state and the discharge into the discharge cut-off state are not actually carried out, therefore, it is possible to count the number of cycles Ncyc which is required for determining the cycle life with high precision.

Also in timings T7 to T9 and timings T9 to T11, subsequently, the counting of the number of cycles Ncyc and the update of the cycle electric quantity Qcyc are repeated by the same processing as in the timings T1 to T3 so that the number of cycles Ncyc is increased. When the number of cycles Ncyc reaches a cycle life NL, it is determined that the secondary battery 14 runs down by the protection control portion 216 so that the discharging switching element SW1 and the charging switching element SW2 are turned OFF. Consequently, the secondary battery 14 running down due to the advanced deterioration can be prevented from being further used continuously. Thus, a safety can be enhanced.

The description has been given to the example in which the cycle counting portion 214 adds the number of cycles Ncyc based on the charge integrated electric quantity Qc obtained by the charging current integrating portion 211 and the cycle electric quantity setting portion 213 sets and updates the cycle electric quantity Qcyc based on the discharge integrated electric quantity Qd obtained by the discharge current integrating portion 212. If the timing for adding the number of cycles Ncyc is different from the timing for updating the cycle electric quantity Qcyc, the same effect can be obtained.

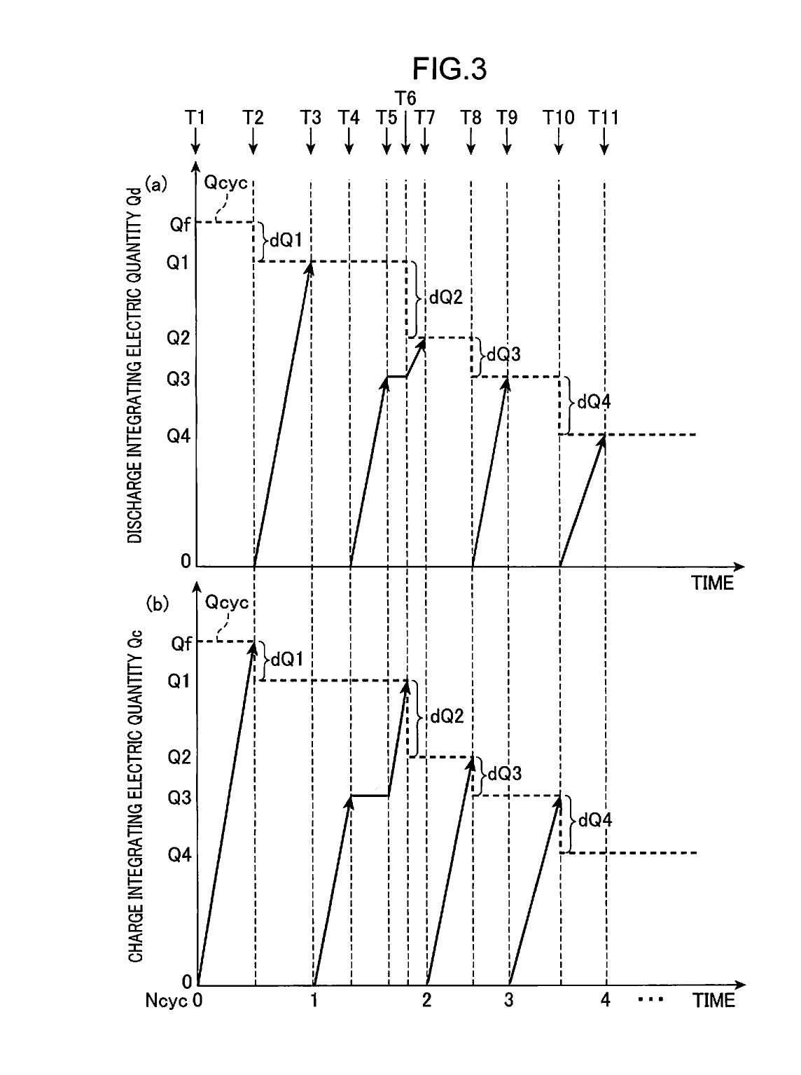

For example, as shown in FIG. 3, the cycle counting portion 214 may add the number of cycles Ncyc based on the discharge integrated electric quantity Qd obtained by the discharging current integrating portion 212, and the cycle electric quantity setting portion 213 may set and update the cycle electric quantity Qcyc based on the charge integrated electric quantity Qc obtained by the charging current integrating portion 211.

FIG. 3 shows an example in which the secondary battery 14 is charged for a period of the timings T1 to T2, T3 to T4, T5 to T6, T7 to T8, and T9 to T10, and the secondary battery 14 is discharged for a period of the timings T2 to T3, T4 to T5, T6 to T7, T8 to T9, and T10 to T11 in the same manner as in FIG. 2.

In an operation shown in FIG. 3, the cycle electric quantity Qcyc is set and updated by the cycle electric quantity setting portion 213 in the timings T2, T6, T8 and T10 in which the charge integrated electric quantity Qc reaches the cycle electric quantity Qcyc. Moreover, one is added to the number of cycles Ncyc by the cycle counting portion 214 in the timings T3, T7, T9 and T11 in which the discharge integrated electric quantity Qd reaches the cycle electric quantity Qcyc.

Also in this case, in each charging/discharging cycle including a set of a discharge in the timings T2 to T3, and a charge in the timings T3 to T6, a set of a discharge in the timings T4 to T7 and a charge in the timings T7 to T8, and a set of a discharge in the timings T8 to T9 and a charge in the timings T9 to T10, capacity values to be used for a decision in one cycle constituted by a charging cycle and a discharging cycle are equal to each other and precision in the counting of the number of cycles Ncyc is enhanced more greatly than in the case in which the addition of the number of cycles Ncyc and the update of the cycle electric quantity Qcyc are executed in an identical timing, in the same manner as in the case shown in FIG. 2.

The addition of the number of cycles Ncyc and the update of the cycle electric quantity Qcyc do not always need to be performed in different timings from each other but both of them may be carried out in a charge timing or a discharge timing.

For example, when the charge integrated electric quantity Qc reaches the cycle electric quantity Qcyc, the cycle counting portion 214 may add the number of cycles Ncyc, and furthermore, the cycle electric quantity setting portion 213 may update the cycle electric quantity Qcyc. For example, when the discharge integrated electric quantity Qd reaches the cycle electric quantity Qcyc, the cycle counting portion 214 may add the number of cycles Ncyc, and furthermore, the cycle electric quantity setting portion 213 may update the cycle electric quantity Qcyc.

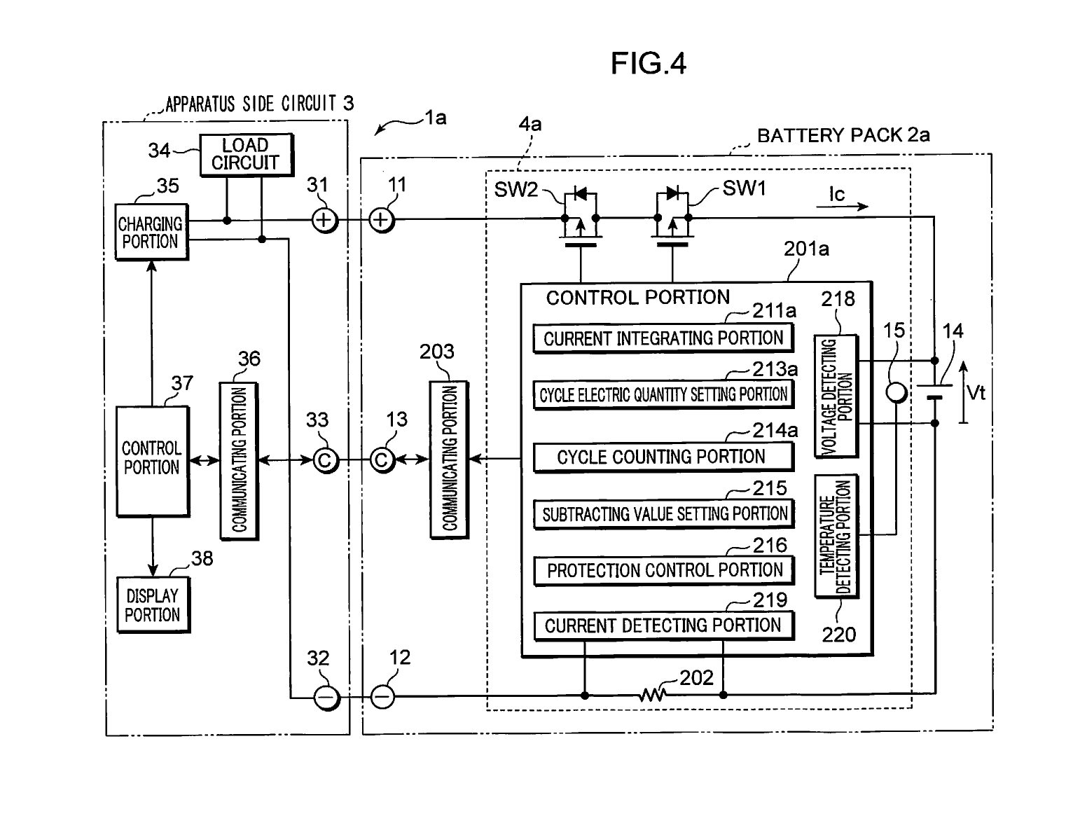

For example, as shown in FIG. 4, a circuit for counting number of cycles 4a may have such a structure as to include a current integrating portion 211a for integrating absolute values of a charging current value and a discharging current value which are detected by the current detecting portion 219 in place of the charging current integrating portion 211 and the discharging current integrating portion 212.

In this case, a cycle electric quantity setting portion 213a subtracts the subtracting value dQ set by the subtracting value setting portion 215 from the cycle electric quantity Qcyc set currently to set a new cycle electric quantity Qcyc every time an increment of an integrated electric quantity Qt calculated by the current integrating portion 211a after a start of a first use of a battery pack 2a and an increment of the integrated electric quantity Qt reaching a last cycle electric quantity Qcyc after the integrated electric quantity Qt once reaches the cycle electric quantity Qcyc reach the cycle electric quantity Qcyc which is currently set.

Moreover, the cycle electric quantity setting portion 213a uses, as an initial value of the cycle electric quantity Qcyc, a value double the full charging capacity value Qf in the initial condition of the secondary battery 14.

The current integrating portion 211a may have such a structure as to integrate only one of the absolute values of the charging current value and the discharging current value which are detected by the current detecting portion 219, thereby calculating the integrated electric quantity Qt. In this case, it is sufficient that the cycle electric quantity setting portion 213a uses, as the initial value of the cycle electric value Qcyc, the full charging capacity value Qf in the initial condition of the secondary battery 14.

A cycle counting portion 214a adds one to the number of cycles Ncyc every time the increment of the integrated electric quantity Qt calculated by the current integrating portion 211a after the start of the first use of the battery pack 2a and the increment of the integrated electric quantity Qt reaching the last cycle electric quantity Qcyc after the integrated electric quantity Qt once reaches the cycle electric quantity Qcyc reach the cycle electric quantity Qcyc which is set by the cycle electric quantity setting portion 213a.

The current integrating portion 211a may reset the integrated electric quantity Qt into zero, thereby integrating the integrated electric quantity Qt again every time the integrated electric quantity Qt reaches the cycle electric quantity Qcyc. In this case, the increment of the integrated electric quantity Qt is equal to the integrated electric quantity Qt itself.

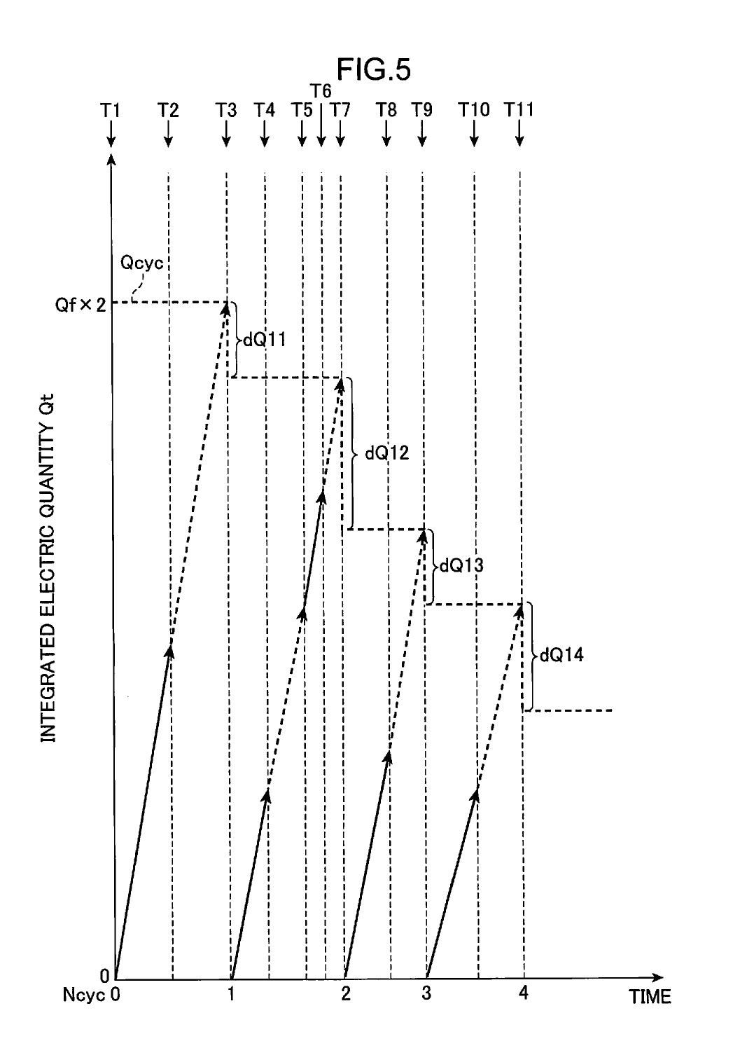

FIG. 5 is an explanatory view showing an example of an operation of the circuit for counting number of cycles 4a illustrated in FIG. 4. In FIG. 5, the charge is shown in a solid-line arrow and the discharge is shown in a broken-line arrow. FIG. 5 shows an example in which the charge/discharge of the secondary battery 14 and a temperature t in each timing are set in the same manner as in FIG. 2, and the secondary battery 14 is charged for a period of timings T1 to T2, T3 to T4, T5 to T6, T7 to T8, and T9 to T10, and the secondary battery 14 is discharged for a period of the timings T2 to T3, T4 to T5, T6 to T7, T8 to T9, and T10 to T11.

In the operation shown in FIG. 5, one is added to the number of cycles Ncyc by the cycle counting portion 214a, and then, the cycle electric quantity Qcyc is further set (updated) by the cycle electric quantity setting portion 213a in the timings T3, T7, T9 and T11 in which the integrated electric quantity Qt reaches the cycle electric quantity Qcyc.

In this case, the subtracting value setting portion 215 sets, as the subtracting values dQ, subtracting values dQ11, dQ12, dQ13 and dQ14 to be an approximately double the subtracting values dQ1, dQ2, dQ3 and dQ4 in FIG. 2 in the timings T3, T7, T9 and T11.

Although the description has been given to the circuit for counting number of cycles capable of enhancing the precision in the counting of the number of cycles in the cycle life in the case in which the secondary battery is not charged into the full charging state or is not discharged into the discharge cut-off state, the secondary battery is charged into the full charging state or is discharged into the discharge cut-off state in a practical use in some cases.

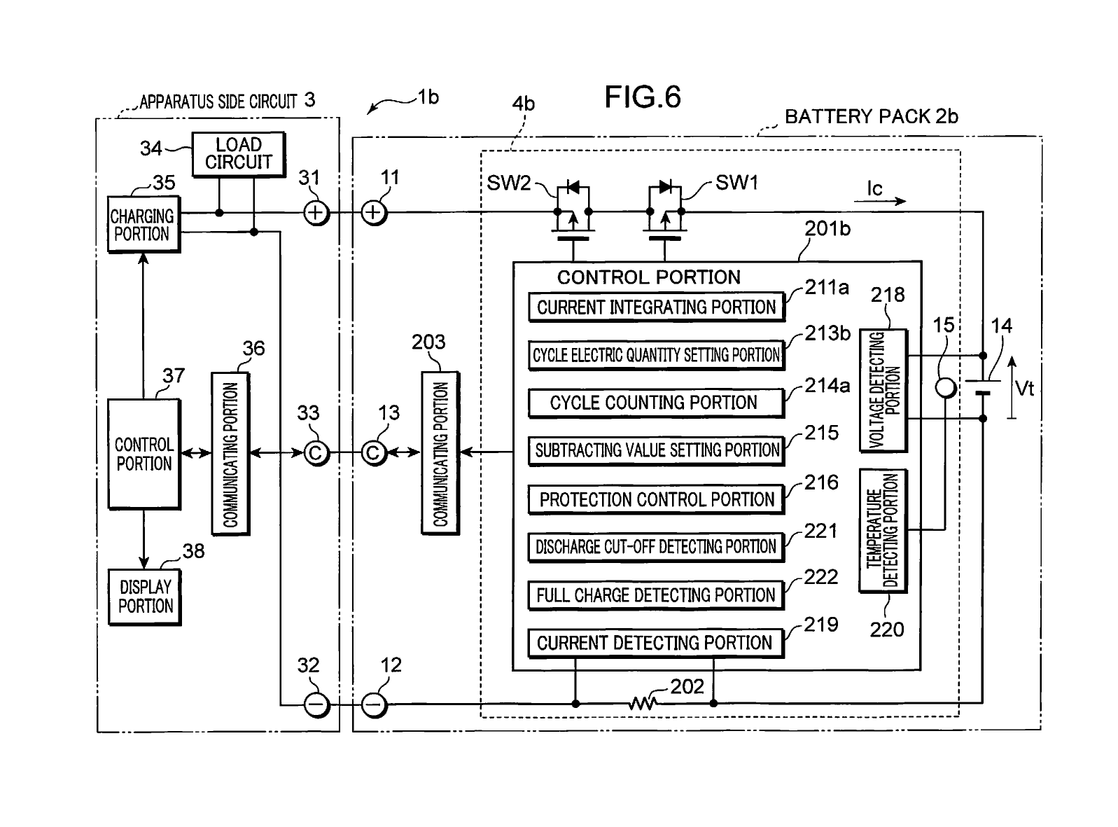

Therefore, a control portion 201b may further include a discharge cut-off detecting portion 221 for detecting that the secondary battery 14 is brought into the discharge cut-off state and a full charge detecting portion 222 for detecting that the secondary battery 14 is brought into the full charging state, as in the battery pack 2b provided in a battery system 1b shown in FIG. 6, for example.

The discharge cut-off detecting portion 221 may detect that the secondary battery 14 is brought into the discharge cut-off state when the terminal voltage Vt of the secondary battery 14 which is detected by the voltage detecting portion 218 is equal to or lower than a preset discharge cut-off voltage, for example, and may detect that the secondary battery 14 is brought into the discharge cut-off state by using the other known methods.

The full charge detecting portion 222 may detect that the secondary battery 14 is brought into the full charging state when the terminal voltage Vt of the secondary battery 14 which is detected by the voltage detecting portion 218 is equal to or higher than a preset full charging voltage, for example, and may detect that the secondary battery 14 is brought into the full charging state by using the other known methods.

In addition to the function of the cycle electric quantity setting portion 213a, the cycle electric quantity setting portion 213b may further set, as the cycle electric quantity Qcyc, the integrated electric quantity which is integrated by the current integrating portion 211a from the time the discharge cut-off state is detected until the time the full charging state is detected in the case in which the secondary battery 14 is continuously charged from the time the discharge cut-off detecting portion 221 detects that the secondary battery 14 is brought into the discharge cut-off state until the time the full charge detecting portion 222 detects that the secondary battery 14 is brought into the full charging state.

Moreover, the cycle electric quantity setting portion 213b may set, as the cycle electric quantity Qcyc, the integrated electric quantity which is integrated by the current integrating portion 211a from the time the full charging state is detected until the time the discharge cut-off state is detected in the case in which the secondary battery 14 is continuously discharged from the time the full charge detecting portion 222 detects that the secondary battery 14 is brought into the full charging state until the time the discharge cut-off detecting portion 221 detects that the secondary battery 14 is brought into the discharge cut-off state.

Therefore, the cycle electric quantity setting portion 213b sets, as the cycle electric quantity Qcyc, the integrated electric quantity which is integrated by the current integrating portion 211a, that is, a measured value of an actual battery capacity of the secondary battery 14, from the time the discharge cut-off state is detected until the time the full charging state is detected, in the case in which the secondary battery 14 is continuously charged from the time the discharge cut-off detecting portion 221 detects that the secondary battery 14 is brought into the discharge cut-off state until the time the full charge detecting portion 222 detects that the secondary battery 14 is brought into the full charging state.

On the other hand, the cycle electric quantity setting portion 213b sets, as the cycle electric quantity Qcyc, the integrated electric quantity which is integrated by the current integrating portion 211a, that is, a measured value of the actual battery capacity of the secondary battery 14, from the time the full charging state is detected until the time the discharge cut-off state is detected, in the case in which the secondary battery 14 is continuously discharged from the time the full charge detecting portion 222 detects that the secondary battery 14 is brought into the full charging state until the time the discharge cut-off detecting portion 221 detects that the secondary battery 14 is brought into the discharge cut-off state. Consequently, the cycle electric quantity Qcyc can be corrected into the actual battery capacity. As a result, it is possible to enhance the precision in the counting of the number of cycles in the cycle life.

By using the charging current integrating portion 211 and the discharging current integrating portion 212 in place of the current integrating portion 211a, the cycle electric quantity setting portion 213b may set the cycle electric quantity Qcyc based on the integrated values of the charging current integrating portion 211 and the discharging current integrating portion 212 in the same manner as the cycle electric quantity setting portion 213.

### Second Embodiment

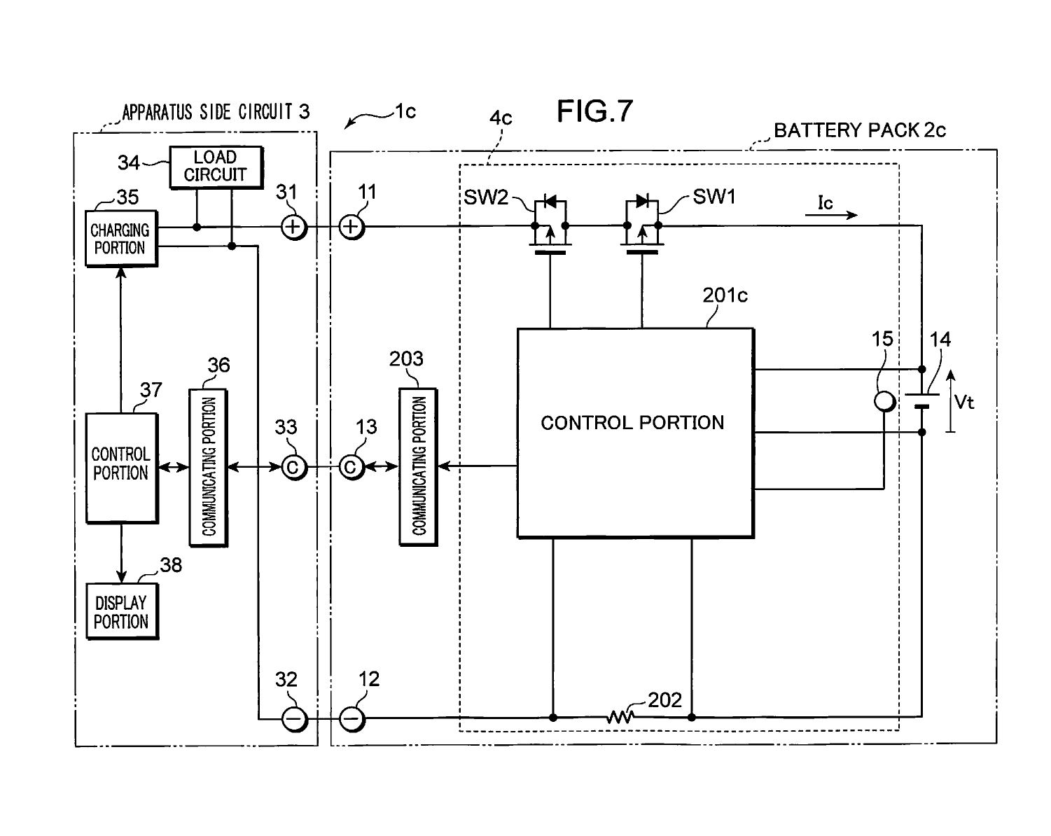

Next, a battery system 1c according to a second embodiment of the present invention will be described. FIG. 7 is a block diagram showing an example of structures of a battery pack 2c and a battery system 1c including a circuit for counting number of cycles 4c according to a second embodiment of the present invention.

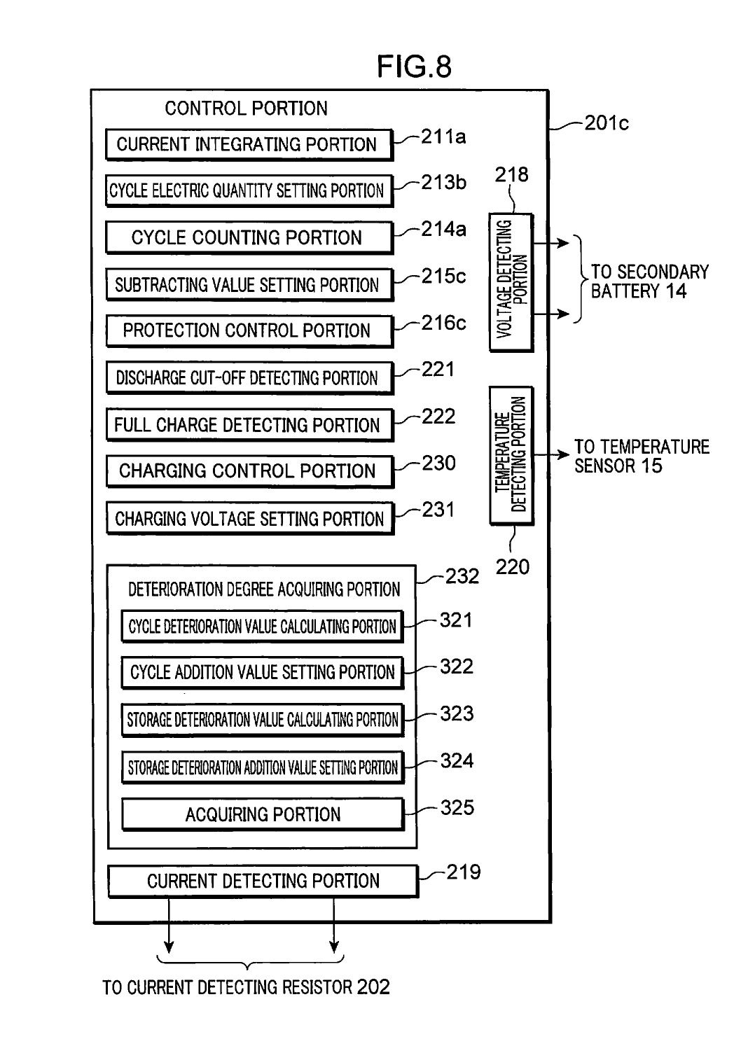

Referring to the battery system 1c shown in FIG. 7 and the battery system 1b shown in FIG. 6, a structure of a control portion 201c provided in the circuit for counting number of cycles 4c is different from that of the control portion 201b. FIG. 8 is a block diagram showing an example of the structure of the control portion 201c illustrated in FIG. 7. The control portion 201c shown in FIG. 8 is different from the control portion 201b shown in FIG. 6 in that the control portion 201c functions as a charging control portion 230, a charging voltage setting portion 231 and a deterioration degree acquiring portion 232, functions as a subtracting value setting portion 215c (a decrement setting portion) in place of the subtracting value setting portion 215, and functions as a protection control portion 216c (life deciding portion) in place of the protection control portion 216.

The deterioration degree acquiring portion 232 includes a cycle deterioration value calculating portion 321, a cycle addition value setting portion 322, a storage deterioration value calculating portion 323, a storage deterioration addition value setting portion 324, and an acquiring portion 325.

The control portion 201c may have such a structure as to include the charging current integrating portion 211 and the discharging current integrating portion 212 in place of a current integrating portion 211a.

Since the other structures are the same as those of the battery system 1b shown in FIG. 6, description thereof will be omitted and features of the present embodiment will be described below.

The charging control portion 230 controls the charge of a secondary battery 14 through a charging portion 35 in such a manner that a terminal voltage Vt of the secondary battery 14 does not exceed a voltage Vf set by the charging voltage setting portion 231.

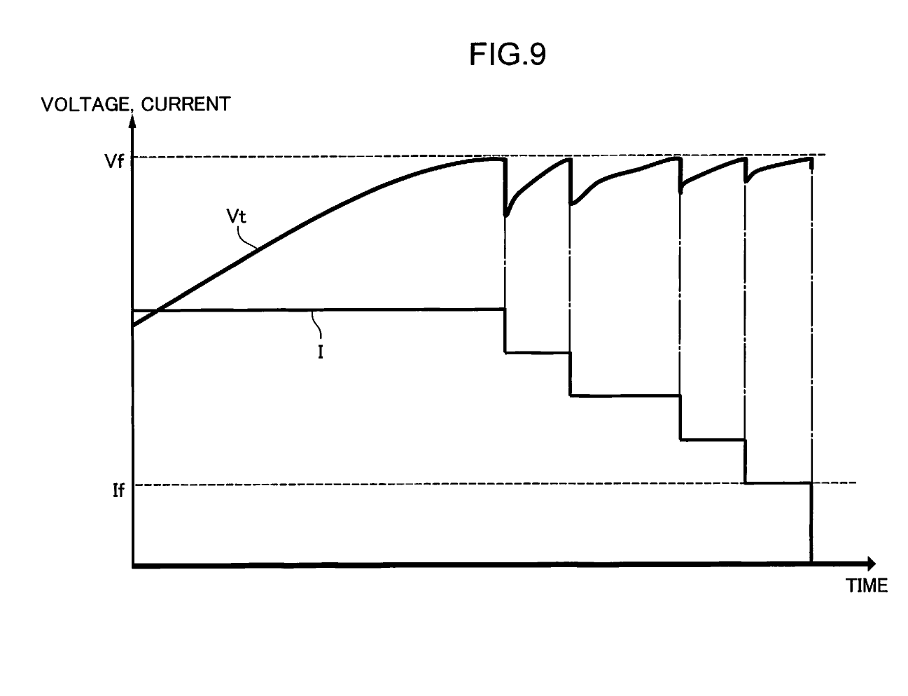

FIG. 9 is a chart for describing an example of an operation of the charging control portion 230 illustrated in FIG. 8. The charging control portion 230 supplies a current I having a predetermined set current value Is to the secondary battery 14 through the charging portion 35, thereby executing constant current charging as shown in FIG. 9, for example. When the terminal voltage Vt detected by a voltage detecting portion 218 reaches the set voltage Vf, the charging control portion 230 decreases the set current value Is to reduce the current I and the terminal voltage Vt, and causes the charging portion 35 to execute the constant current charging until the terminal voltage Vt reaches the set voltage Vf again.

Thus, the charging control portion 230 repeats the constant current charging while decreasing the set current value Is every time the terminal voltage Vt reaches the set voltage Vf, and stops the supply of the current through the charging portion 35, thereby ending the charge of the secondary battery 14 when the set current value Is is equal to or smaller than a preset termination current value If.

It is only necessary for the charging control portion 230 to control the charge of the secondary battery 14 in such a manner that the terminal voltage Vt of the secondary battery 14 does not exceed the set voltage Vf. For example, the charging control portion 230 may supply the voltage Vf set by the charging voltage setting portion 231 as a charging voltage of the secondary battery 14 through the charging portion 35, thereby carrying out constant voltage charging or CCCV (Constant Current Constant Voltage) charging, and may use the other charging methods.

According to the charging method described above, the secondary battery 14 can be charged in such a manner that the terminal voltage Vt of the secondary battery 14 does not exceed the set voltage Vf.

The charging voltage setting portion 231 reduces the set voltage Vf more with a greater increase in an extent of a deterioration represented by a deterioration degree D which is acquired by the deterioration degree acquiring portion 232.

The subtracting value setting portion 215c sets a subtracting value dQ to be decreased more when the set voltage Vf set by the charging voltage setting portion 231 is reduced more.

Referring to the secondary battery, a decrement of a full charging capacity due to the deterioration is increased more when a charging voltage in the charge is raised more. When the set voltage Vf set by the charging voltage setting portion 231 is reduced so that the charging voltage of the secondary battery 14 is dropped, accordingly, a decrement of a full charging capacity in a single charging/discharging cycle (SOC: 0%→100%→0%) is lessened.

Therefore, the decrement of the full charging capacity in the single charging/discharging cycle (SOC: 0%→100%→0%) is experimentally obtained corresponding to the charging voltage of the secondary battery and is thus set to be the subtracting value dQ, for example, and the subtracting value dQ and the charging voltage, that is, the set voltage Vf are caused to correspond to each other, thereby creating a data table. Then, the data table is prestored in a ROM, for example.

The subtracting value setting portion 215c sets the subtracting value dQ corresponding to the set voltage Vf of the secondary battery 14 with reference to the data table thus obtained, thereby setting the subtracting value dQ to be decreased more when the set voltage Vf is reduced more.

The subtracting value setting portion 215c may set a subtraction ratio in place of the subtracting value dQ in the same manner as in the case of the subtracting value setting portion 215. In this case, a reduction ratio is set to approximate more to one when the set voltage Vf set by the charging voltage setting portion 231 is reduced more.

Moreover, the subtracting value setting portion 215c may set the subtracting value dQ in order to be decreased more when the set voltage Vf is reduced more as well as to be increased more when the temperature t is apt to deteriorate the secondary battery 14 more, that is, to be decreased more when it is harder for the temperature t to deteriorate the secondary battery 14.

In this case, for example, the decrement of the full charging capacity in the single charging/discharging cycle (SOC: 0%→100%→0%) may be experimentally obtained to create a data table corresponding to a combination of the set voltage Vf and the temperature t, and the data table may be prestored in the ROM, for example. The subtracting value setting portion 215c may set the subtracting value dQ corresponding to the combination of the set voltage Vf of the secondary battery 14 and the temperature t with reference to the data table thus obtained, thereby setting the subtracting value dQ.

The deterioration degree acquiring portion 232 acquires the deterioration degree D to be an index representing the extent of the deterioration in the secondary battery 14 by using the cycle deterioration value calculating portion 321, the cycle addition value setting portion 322, the storage deterioration value calculating portion 323, the storage deterioration addition value setting portion 324 and the acquiring portion 325.

The cycle addition value setting portion 322 sets a cycle addition value Adc to be decreased more when the voltage Vf set by the charging voltage setting portion 231 is reduced more.

When the set voltage Vf is reduced so that the charging voltage of the secondary battery 14 is dropped more, an extent of deterioration in the secondary battery 14 which occurs in a single charging/discharging cycle is reduced more. Therefore, the cycle addition value setting portion 322 decreases the cycle addition value Adc more when the set voltage Vf is reduced more. Consequently, it is possible to enhance precision representing the extent of the deterioration in the secondary battery 14 which occurs in the single charging/discharging cycle.

Every time one is added to the number of cycles Ncyc by the cycle counting portion 214a, the cycle deterioration value calculating portion 321 integrates the cycle addition value Adc set by the cycle addition value setting portion 322, thereby calculating a cycle deterioration value Dcyc representing the extent of the cycle deterioration.

The storage deterioration value calculating portion 323 integrates a storage deterioration addition value Ads set by the storage deterioration addition value setting portion 324 every unit time, thereby calculating a storage deterioration value Dst representing the extent of the storage deterioration.

The storage deterioration addition value setting portion 324 sets the storage deterioration addition value Ads to be increased more when a temperature t detected by a temperature detecting portion 220 tends to deteriorate the secondary battery 14 more depending on the temperature t, that is, a difference between the upper and lower limits within the suitable temperature range or an optimum temperature and the temperature t is increased more.

The secondary battery generally causes deterioration to some degree in a storage state even if the charge/discharge is not carried out. The extent of the deterioration is related to the temperature t. Therefore, the storage deterioration addition value setting portion 324 increases the storage deterioration addition value Ads more if the temperature t tends to deteriorate the secondary battery 14 more depending on the temperature t detected by the temperature detecting portion 220.

When the storage deterioration value calculating portion 323 integrates the storage deterioration addition value Ads thus set every unit time, thereby calculating the storage deterioration value Dst, the storage deterioration value Dst serves as an index indicative of an extent of an aging deterioration caused in the storage state in the secondary battery 14.

The acquiring portion 325 calculates a deterioration degree D by using the following Equation (1), for example, based on the cycle deterioration value Dcyc calculated by the cycle deterioration value calculating portion 321 and the storage deterioration value Dst calculated by the storage deterioration value calculating portion 323.

Deterioration degree D=Dcyc+Dst (1)

The acquiring portion 325 may use, for example, the cycle deterioration value Dcyc unchanged as the deterioration degree D without using the Equation (1).

If the deterioration degree D calculated by the acquiring portion 325 exceeds a preset life decision value L (a life decision level), the protection control portion 216c determines that the secondary battery 14 runs down and turns OFF a discharging switching element SW1 and a charging switching element SW2, thereby prohibiting the charge/discharge of the secondary battery 14, for example.

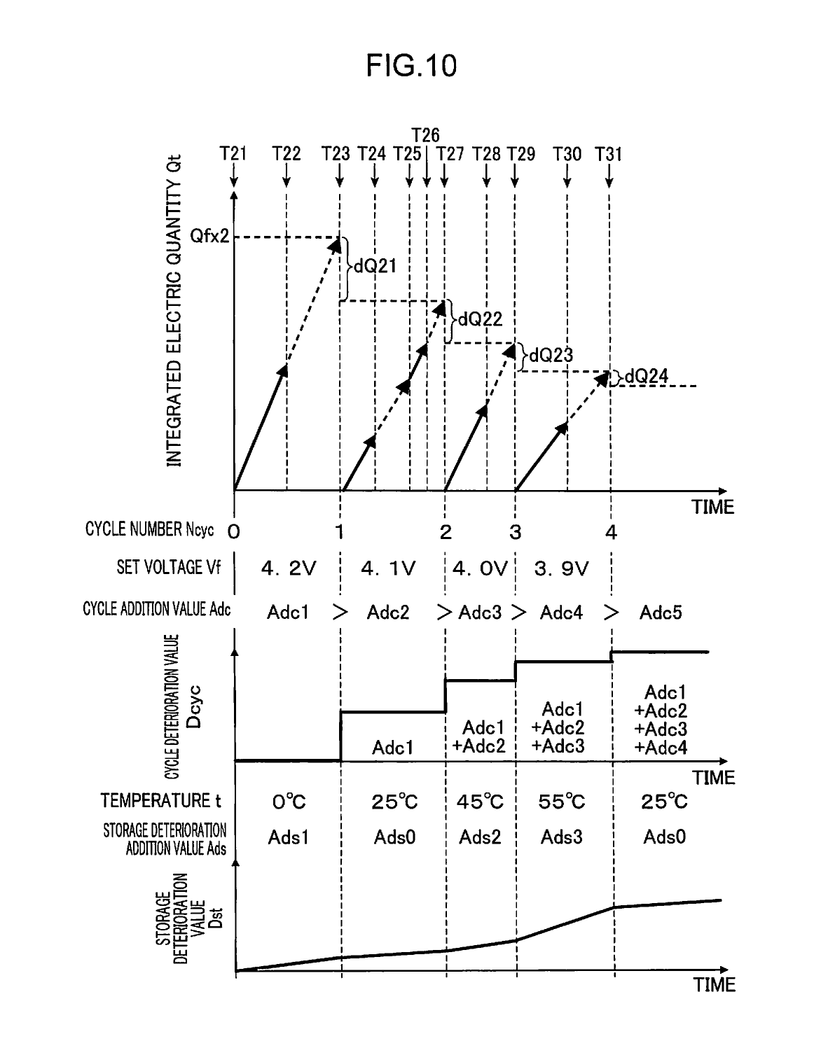

Next, an operation of the battery system 1c shown in FIG. 7 will be described. FIG. 10 is an explanatory chart showing an example of the operation of the battery system 1c illustrated in FIG. 7. In FIG. 10, a graph indicating an integrated electric quantity Qt shows a charge in a solid-line arrow and a discharge in a broken-line arrow. FIG. 10 illustrates an example in which the secondary battery 14 is charged for a period of timings T21 to T22, T23 to T24, T25 to T26, T27 to T28, and T29 to T30, and the secondary battery 14 is discharged for a period of the timings T22 to T23, T24 to T25, T26 to T27, T28 to T29, and T30 to T31.

First of all, in the initial timing T21, the integrated electric quantity Qt is zero and the number of cycles Ncyc is also set to be zero. As the cycle electric quantity Qcyc, a full charging capacity value Qf×2 is set as an initial value. In the initial condition (the timing T21), the secondary battery 14 is not deteriorated and the deterioration degree D is zero. At this time, the set voltage Vf is set to be 4.2 V, for example.

Adc1 is set as the cycle addition value Adc corresponding to the deterioration degree of D=0 by the cycle addition value setting portion 322.

Moreover, it is assumed that the temperature t is 0° C. for the period of the timings T21 to T23, for example. Consequently, Ads1 is set as the storage deterioration addition value Ads corresponding to the temperature t=0° C. by the storage deterioration addition value setting portion 324, for example.

FIG. 10 illustrates an example in which the temperature t is 25° C. for the period of the timings T23 to T27, the temperature t is 45° C. for the period of the timings T27 to T29, the temperature t is 55° C. for the period of the timings T29 to T31, and the temperature t is 25° C. in the timing T31 and thereafter.

Although FIG. 10 shows an example in which the temperature t is varied every cycle for easy description, the storage deterioration addition value Ads is actually set depending on a change in the temperature t asynchronously with a charging/discharging cycle.

When the secondary battery 14 is charged into a full charge (SOC: 100%) in the timings T21 to T22 and is discharged until the SOC reaches 0% in the timings T22 to T23, an absolute value of a charging/discharging current is integrated by the current integrating portion 211a so that the integrated electric quantity Qt is increased.

When the integrated electric quantity Qt is equal to or larger than the full charging capacity value Qf×2, that is, the cycle electric quantity Qcyc (the timing T23), the cycle counting portion 214a adds one to the number of cycles Ncyc. As described above, a transmission of the number of cycles Ncyc and display processing are executed.

In the timings T21 to T23, moreover, the storage deterioration addition value Ads (=Ads1) is integrated every unit time so that the storage deterioration value Dst representing an extent of a storage deterioration is calculated by the storage deterioration value calculating portion 323. Consequently, the storage deterioration value Dst is gradually increased.

When the discharging integrated electric quantity Qd is equal to the full charging capacity value Qf×2, that is, the cycle electric quantity Qcyc (the Timing T23), next, a subtracting value dQ corresponding to the set voltage Vf (4.2 V) corresponding to the charging/discharging cycle of the timings T21 to T23 is set as dQ21 by the subtracting value setting portion 215c, for example. Although the subtracting value setting portion 215c may set the subtracting value dQ based on the set voltage Vf and the temperature t, description will be given to an example in which the subtracting value setting portion 215c sets the subtracting value dQ based on only the set voltage Vt for easy description.

Subsequently, a subtracting value dQ21 is subtracted from a current cycle electric quantity Qcyc (=the full charging capacity value Qf×2) by the cycle electric quantity setting portion 213, and the calculated value is set as a new cycle electric quantity Qcyc (Qcyc←Qcyc−dQ).

In other words, the cycle electric quantity Qcyc is decreased depending on a reduction in the battery capacity of the secondary battery 14 which occurs in the charging/discharging cycle in the timings T21 to T23. In a next charging/discharging cycle, therefore, it is possible to enhance precision in counting of the number of cycles Ncyc based on the cycle electric quantity Qcyc.

In the timing T23 in which one is added to the number of cycles Ncyc, furthermore, the cycle addition value Adc (=Adc1) is integrated by the cycle deterioration value calculating portion 321 so that a cycle deterioration value Dcyc is calculated (Dcyc←Dcyc+Adc1).

In the timing T23, then, the cycle deterioration value Dcyc calculated by the cycle deterioration value calculating portion 321 and the storage deterioration value Dst calculated by the storage deterioration value calculating portion 323 are added by the acquiring portion 325 so that the deterioration degree D is calculated.

Consequently, the deterioration degree D is reflected by the cycle deterioration and the storage deterioration which occur over the secondary battery 14 in the timings T21 to T23. Therefore, the deterioration degree D can represent the extent of the deterioration in the secondary battery 14 with high precision.

When the deterioration degree D is calculated by the acquiring portion 325 in the timing T23, subsequently, the voltage Vf to be used in a next charging cycle is set by the charging voltage setting portion 231 depending on the deterioration degree D thus calculated. More specifically, when the extent of the deterioration which is represented by the deterioration degree D is increased more, the set voltage Vf is reduced more by the charging voltage setting portion 231. FIG. 10 shows an example in which the set voltage Vf is reduced from 4.2 V to 4.1 V.

Thus, when the extent of the deterioration which is represented by the deterioration degree D is increased more, the set voltage Vf is reduced more by the charging voltage setting portion 231 so that a charging voltage is dropped, whereby the deterioration in the secondary battery 14 is advanced slowly.

FIG. 10 illustrates the example in which the set voltage Vf is reduced by 0.1 V every time one is added to the number of cycles Ncyc, that is, every charging/discharging cycle. However, it is not always necessary to reduce the set voltage Vf every charging/discharging cycle, and it is sufficient to set a dropped voltage quantity of the set voltage Vf depending on the deterioration degree D. It is not restricted to the example in which the reduction is carried out by 0.1 V at a time.

For example, the charging voltage setting portion 231 may drop the set voltage Vf depending on the deterioration degree D for a plurality of preset charging/discharging cycles. Alternatively, the charging voltage setting portion 231 may provide at least one threshold before the deterioration degree D reaches the life decision value L from zero, and the set voltage Vf may be dropped depending on the deterioration degree D every time the deterioration degree D reaches the threshold.

In the timing T23 in which one is added to the number of cycles Ncyc, processing in a next charging/discharging cycle is executed by using a newly set voltage Vf and the cycle addition value Adc. In each cycle of the subsequent timings T23 to T27, T27 to T29, and T29 to T31, thus, the same processing as in the timings T21 to T23 is repeated.

In each cycle of the timings T21 to T23, the timings T23 to T27, the timings T27 to T29, and the timings T29 to T31, the set voltage Vf is sequentially dropped so that the charging voltage is reduced. Consequently, there is decreased a decrement for each cycle of the full charging capacity which is generated due to the deterioration in the secondary battery 14 in charging.

Therefore, the subtracting value setting portion 215c sets dQ21, dQ22, dQ23 and dQ24 as the subtracting value dQ corresponding to each cycle of the timings T21 to T23, the timings T23 to T27, the timings T27 to T29, and the timings T29 to T31 respectively in order to decrease the subtracting value dQ more when the set voltage Vf is dropped more. Consequently, it is possible to enhance precision in which the cycle electric quantity Qcyc to be set by the cycle electric quantity setting portion 213b represents a charging/discharging electric quantity in an original single charging/discharging cycle of the secondary battery 14 (SOC: 0%→100%→0%). As a result, it is possible to improve precision in the counting of the number of cycles in the cycle life. Herein, there is obtained a relationship of dQ21>dQ22>dQ23>dQ24.

Moreover, the cycle addition value setting portion 322 sets Adc1, Adc2, Adc3 and Adc4 as the cycle addition value Adc corresponding to each cycle of the timings T21 to T23, the timings T23 to T27, the timings T27 to T29, and the timings T29 to T31 respectively in order to decrease the cycle addition value Adc more when the set voltage Vf is dropped more. Consequently, it is possible to enhance precision in which the cycle deterioration value Dcyc to be calculated by the cycle deterioration value calculating portion 321 represents an extent of cycle deterioration. Herein, there is obtained a relationship of Adc1>Adc2>Adc3>Adc4.

For example, moreover, Ads1, Ads0, Ads2, Ads3 and Ads0 are set as the storage deterioration addition value Ads by the storage deterioration addition value setting portion 324 corresponding to the temperature t=0° C. in the timings T21 to T23, the temperature t=25° C. in the timings T23 to T27, the temperature t=45° C. in the timings T27 to T29, the temperature t=55° C. in the timings T29 to T31, and the temperature t=25° C. in the timing T31 and thereafter, respectively.

If 25° C. is an optimum temperature, for example, Ads0 is set to be the smallest value by the storage deterioration addition value setting portion 324. 0° C. is lower than the optimum temperature or the lower limit of the suitable temperature range. For this reason, Ads 1 corresponding to 0° C. is set to have a greater value than Ads0 by the storage deterioration addition value setting portion 324.

Since 45° C. is higher than the optimum temperature, Ads2 corresponding to 45° C. may be set to be a greater value than Ads0 by the storage deterioration addition value setting portion 324. Since 45° C. is within the suitable temperature range, moreover, it may be set to be an equal value to Ads0 by the storage deterioration addition value setting portion 324. Since 55° C. has a greater difference from the optimum temperature or the upper limit of the suitable temperature range than 45° C., Ads3 corresponding to 55° C. is set to be a greater value than Ads2 by the storage deterioration addition value setting portion 324.

Consequently, the influence of the temperature on deterioration in the storage which is caused in the storage state of the secondary battery 14 is reflected so that the storage deterioration value Dst is calculated. Therefore, it is possible to enhance precision in which the storage deterioration value Dst indicates the extent of the storage deterioration. The deterioration degree D acquired by the acquiring portion 325 includes cycle deterioration caused with the charging/discharging cycle and the storage deterioration caused in the storage state depending on a temperature environment and represents the extent of the deterioration in the secondary battery 14. Thus, it is possible to improve the extent of the deterioration which is represented by the deterioration degree D.

As described above, the same processing as in the timings T21 to T23 is repeated. Consequently, the deterioration degree D indicative of the extent of the deterioration in the secondary battery 14 can be calculated with high precision, and the charging voltage of the secondary battery 14 is reduced depending on an increase in the deterioration degree D. As a result, the deterioration in the secondary battery 14 is advanced slowly.

When the deterioration degree D calculated by the acquiring portion 325 exceeds the life decision value L, the protection control portion 216c determines that the secondary battery 14 runs down, and the charge/discharge of the secondary battery 14 is thus prohibited. Consequently, a concern that a safety might be reduced by using the secondary battery 14 running down continuously is reduced.

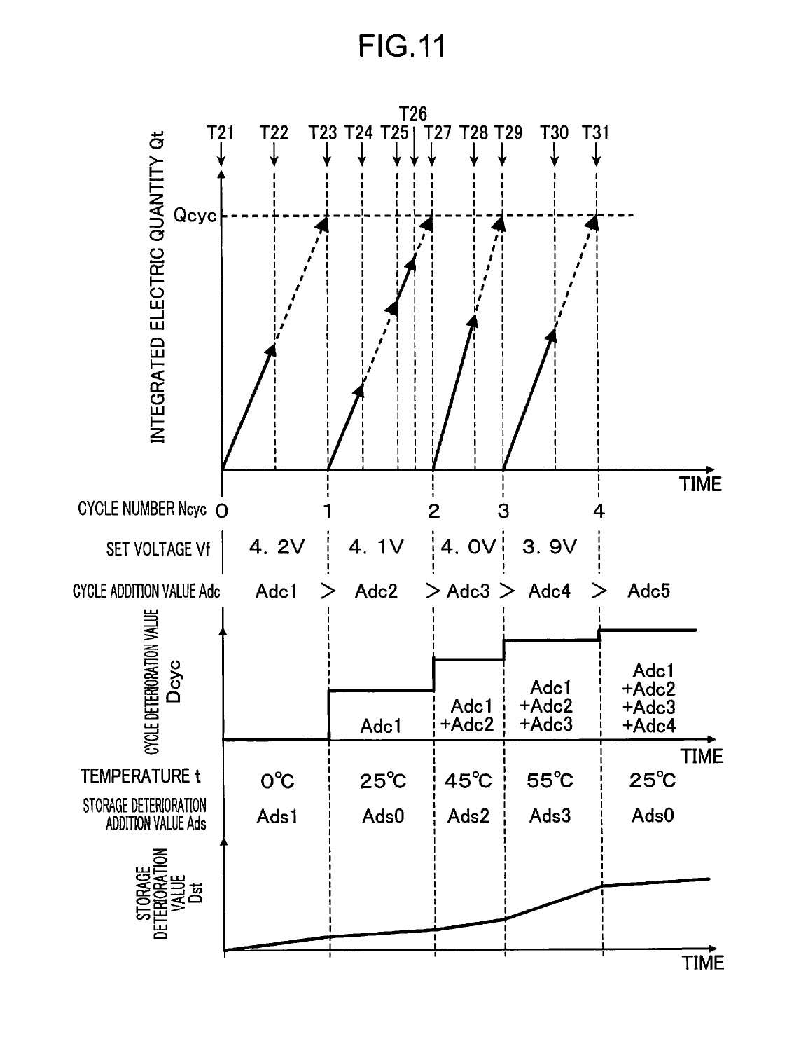

The control portion 201c may include neither the cycle electric quantity setting portion 213b nor the subtracting value setting portion 215c, and the cycle counting portion 214a provided in the control portion 201c may use the preset cycle electric quantity Qcyc. FIG. 11 is an explanatory chart showing an example of the operation of the circuit for counting number of cycles 4c in the case of the structure in which the cycle electric quantity setting portion 213b and the subtracting value setting portion 215c are not provided.

In this case, it is possible to use, as the cycle electric quantity Qcyc, a value which is double the full charging capacity value Qf of the secondary battery 14, for example. In the case in which the charging current integrating portion 211 and the discharging current integrating portion 212 are used in place of the current integrating portion 211a or the case in which the current integrating portion 211a has such a structure as to integrate only either of the charging current value detected by the current detecting portion 219 or an absolute value of the discharging current value, thereby calculating the integrated electric quantity Qt, alternatively, the full charging capacity value Qf of the secondary battery 14 can be used as the cycle electric quantity Qcyc, for example.

With such a structure, the charging voltage is controlled to be reduced more with a greater increase in the extent of the deterioration in the secondary battery 14. As a result, the deterioration in the secondary battery 14 is advanced slowly. Moreover, it is possible to enhance precision in the deterioration which is indicated by the cycle deterioration value Dcyc and precision in the deterioration which is indicated by the storage deterioration value Dst. As a result, it is possible to improve precision in the deterioration degree D which is acquired by the acquiring portion.

More specifically, a circuit for counting number of cycles according to an aspect of the present invention includes: a current detecting portion that detects a current value of a current flowing to a secondary battery; a current integrating portion that calculates, as an integrated electric quantity, an integrated value of the current value detected by the current detecting portion; a cycle electric quantity setting portion that successively sets a cycle electric quantity corresponding to one cycle of a cycle life of the secondary battery; and a cycle counting portion that counts a number of cycles of the cycle life, wherein the cycle counting portion adds one to the last counted number of cycles when an increment of the integrated electric quantity calculated by the current integrating portion after the number of cycles is counted last time reaches a last set cycle electric quantity, and the cycle electric quantity setting portion decreases a predetermined decrement from the last set cycle electric quantity to set a new cycle electric quantity when the increment of the integrated electric quantity calculated by the current integrating portion after the number of cycles is counted last time reaches the last set cycle electric quantity.

According to the structure, the cycle electric quantity to be a reference for determining one cycle part in the cycle life of the secondary battery is set by the cycle electric quantity setting portion. When the increment of the integrated electric quantity calculated by the current integrating portion after the cycle counting portion counts the last cycle number reaches the cycle electric quantity set by the cycle electric quantity setting portion, one is added to the number of cycles and the number of cycles is counted by the cycle counting portion. Also in the case in which the secondary battery is not charged into a full charging state or is not discharged into a discharging cut-off state, accordingly, it is possible to count the number of cycles in the cycle life.

The secondary battery is gradually deteriorated via each charging/discharging cycle so that the full charging capacity is decreased. In the charging/discharging cycle in an original cycle life, accordingly, a full charging capacity is decreased every time the charge from the discharging cut-off state to the full charge and the discharge from the full charge to the discharging cut-off state are repeated. In the original cycle life, therefore, an electric quantity (a quantity of electric charges) to be charged/discharged in a subsequent single charging/discharging cycle is smaller than an electric quantity (a quantity of electric charges) to be charged/discharged in an initial single charging/discharging cycle.

For this reason, if the cycle electric quantity has a fixed value, the number of cycles counted by the cycle counting portion has an error between the number of cycles in the original cycle life so that precision in the counting of the number of cycles is deteriorated.

According to the structure, however, when the increment of the integrated electric quantity, calculated by the current integrating portion after the cycle number is counted by the cycle counting portion previous time, reaches a currently set cycle electric quantity, that is, an electric quantity corresponding to one cycle in the cycle life flows to the secondary battery, the electric quantity is decreased by a predetermined decrement from a current cycle electric quantity to set a new cycle electric quantity by the cycle electric quantity setting portion.

Even if the charging/discharging cycle constituted by the charge from the discharging cut-off state to the full charging state and the discharge from the full charging state to the discharging cut-off state is not actually executed, consequently, the cycle electric quantity is decreased in the same manner as a decrease in the full charging capacity which is caused by a deterioration in the secondary battery due to the charging/discharging cycle, and a next cycle number is counted by the cycle counting portion based on the cycle electric quantity thus decreased. Accordingly, there is decreased a difference between the number of cycles in the original cycle life and the number of cycles counted by the cycle counting portion. As a result, it is possible to enhance the precision in the counting of the number of cycles.

Moreover, the current integrating portion may include: a charging current integrating portion that integrates current values detected by the current detecting portion when the secondary battery is charged; and a discharging current integrating portion that integrates current values detected by the current detecting portion when the secondary battery is discharged, wherein the cycle counting portion may add one to the last counted number of cycles when an increment of an integrated electric quantity calculated by the charging current integrating portion after the number of cycles is counted last time reaches a last set cycle electric quantity, and the cycle electric quantity setting portion may decrease the decrement from the last set cycle electric quantity to set a new cycle electric quantity when an increment of the integrated electric quantity calculated by the discharging current integrating portion after the number of cycles is counted last time reaches the last set cycle electric quantity.

According to the structure, the cycle counting portion uses the charging current integrating portion as the current integrating portion described above. When the increment of the integrated value of the charging current integrated during the charge of the secondary battery by the charging current integrating portion which is obtained after the cycle number is counted last time reaches the cycle electric quantity set by the cycle electric quantity setting portion, therefore, one is added to the number of cycles by the cycle counting portion. On the other hand, the cycle electric quantity setting portion uses the discharging current integrating portion as the above-described current integrating portion. When the increment of the integrated value of the discharging current integrated during the discharge of the secondary battery by the discharging current integrating portion which is obtained after the cycle number is counted last time reaches the cycle electric quantity set at a last time, that is, the cycle electric quantity set at that time, therefore, the cycle electric quantity is decreased by a predetermined decrement so that a new cycle electric quantity is set.

Consequently, the number of cycles is counted in the charge of the secondary battery, and the cycle electric quantity is updated in the discharge of the secondary battery. As a result, it is possible to reduce the counting error of the number of cycles which is made when the counting of the number of cycles and the update of the cycle electric quantity of the number of cycles are carried out in the same timing.

Moreover, the current integrating portion may include: a charging current integrating portion that integrates current values detected by the current detecting portion when the secondary battery is charged; and a discharging current integrating portion that integrates current values detected by the current detecting portion when the secondary battery is discharged, wherein the cycle counting portion may add one to the last counted number of cycles when an increment of an integrated electric quantity calculated by the discharging current integrating portion after the number of cycles is counted last time reaches a last set cycle electric quantity, and the cycle electric quantity setting portion may decrease the decrement from the last set cycle electric quantity to set a new cycle electric quantity when an increment of the integrated electric quantity calculated by the charging current integrating portion after the number of cycles is counted last time reaches the last set cycle electric quantity.

According to the structure, the cycle counting portion uses the discharging current integrating portion as the current integrating portion described above. When the increment of the integrated value of the discharging current which is integrated during the discharge of the secondary battery by the discharging current integrating portion which is obtained after the cycle number is counted last time reaches the cycle electric quantity set by the cycle electric quantity setting portion, therefore, one is added to the number of cycles by the cycle counting portion. On the other hand, the cycle electric quantity setting portion uses the charging current integrating portion as the above-described current integrating portion. When the increment of the integrated value of the charging current integrated during the charge of the secondary battery by the charging current integrating portion which is obtained after the cycle number is counted by the cycle counting portion last time reaches the cycle electric quantity set at that time, therefore, the cycle electric quantity is decreased by a predetermined decrement so that a new cycle electric quantity is set.

Consequently, the number of cycles is counted in the discharge of the secondary battery and the cycle electric quantity is updated in the charge of the secondary battery. As a result, it is possible to reduce a counting error of the number of cycles which is made when the counting of the number of cycles and the update of the cycle electric quantity are carried out in the same timing.

Moreover, it is preferable that the current integrating portion integrates current values detected by the current detecting portion either during the charge or the discharge of the secondary battery.

According to the structure, the integrated value which is obtained by the current integrating portion is smaller compared with the case in which the current value is integrated through both the charge and the discharge. Therefore, it is possible to decrease a data volume to be handled.

In addition, it is preferable that the cycle electric quantity setting portion sets a full charging capacity value in an initial condition of the secondary battery as an initial cycle electric quantity which is an initial value of the cycle electric quantity, and the cycle counting portion adds one to the number of cycles when the integrated electric quantity calculated by the current integrating portion reaches the initial cycle electric quantity in an execution of first counting of the number of cycles.

According to the structure, the full charging capacity value in the initial condition of the secondary battery is used as the initial value of the cycle electric quantity by the cycle electric quantity setting portion. By the repetition of the charge from the discharging cut-off state to the full charging state and the discharge from the full charging state to the discharging cut-off state, over the secondary battery in the initial condition, therefore, the same cycle number as in the case of the counting of the number of cycles in the original cycle life can be counted even if the charge into the full charging state is not carried out or the discharge into the discharging cut-off state is not carried out.

Moreover, the current integrating portion may calculate the integrated electric quantity by integrating a current value during charging and a current value during discharging, which are detected by the current detecting portion, and the cycle electric quantity setting portion may set, as an initial value of the cycle electric quantity, a value which is double of a full charging capacity value in an initial condition of the secondary battery.

According to the structure, the integrated value integrated by the current integrating portion is a total value of the charging current and the discharging current. Therefore, the integrated electric quantity in the charging/discharging cycle corresponding to one cycle of the cycle life is a double the full charging capacity value of the secondary battery. By using a value which is double the full charging capacity value in the initial condition of the secondary battery as the initial value of the cycle electric quantity, therefore, it is possible to count the same cycle number as in the case of the counting of the number of cycles in the original cycle life through the repetition of the charge from the discharging cut-off state to the full charging state and the discharge from the full charging state to the discharging cut-off state even if the secondary battery in the initial condition is not charged into the full charging state or is not discharged into the discharging cut-off state.

Moreover, it is preferable to further include a notifying portion that gives a notice of information about a life of the secondary battery corresponding to the number of cycles counted by the cycle counting portion.

According to the structure, the notice of the information about the life of the secondary battery corresponding to the number of cycles counted by the cycle counting portion is given by the notifying portion. Therefore, a user can know the life of the secondary battery.

Moreover, it is preferable to further include: a switching element that opens and closes a charge/discharge path to be charged/discharged by the secondary battery; and a protection control portion that turns off the switching element when the number of cycles counted by the cycle counting portion is equal to or greater than the number of cycles indicating that the cycle life of the secondary battery has ended.

According to the structure, when deterioration in the secondary battery is advanced so that the secondary battery runs down, the charge/discharge path of the secondary battery is blocked so that the charge/discharge is prohibited. Consequently, a safety can be enhanced.

Furthermore, it is preferable to further include: a discharge cut-off detecting portion that detects that the secondary battery is brought into a discharge cut-off state; and a full charge detecting portion that detects that the secondary battery is brought into a full charge state, wherein the cycle electric quantity setting portion further sets, in a case where the secondary battery is continuously charged from a time the discharge cut-off detecting portion detects that the secondary battery is brought into the discharge cut-off state until a time the full charge detecting portion detects that the secondary battery is brought into the full charge state, the integrated electric quantity integrated by the current integrating portion from the time the discharge cut-off state is detected until the time the full charge state is detected as the cycle electric quantity, and sets, in a case where the secondary battery is continuously discharged from a time the full charge detecting portion detects that the secondary battery is brought into the full charge state until a time the discharge cut-off detecting portion detects that the secondary battery is brought into the discharge cut-off state, the integrated electric quantity integrated by the current integrating portion from the time the full charge state is detected until the time the discharge cut-off state is detected as the cycle electric quantity.

In the case in which the secondary battery is charged from the discharging cut-off state to the full charging state, the integrated electric quantity in the meantime indicates an actual measured value of a battery capacity of the secondary battery. In the case in which the secondary battery is discharged from the full charging state to the discharging cut-off state, moreover, the integrated electric quantity in the meantime indicates an actual measured value of the battery capacity of the secondary battery.

Therefore, in a case where the secondary battery is continuously charged from a time the discharge cut-off detecting portion detects that the secondary battery is brought into the discharge cut-off state until a time the full charge detecting portion detects that the secondary battery is brought into the full charge state, the cycle electric quantity setting portion sets, as the cycle electric quantity, the integrated electric quantity integrated by the current integrating portion from the time of the detection of the discharging cut-off state to the time of the detection of the full charging state, that is, the actual measured value of the battery capacity of the secondary battery.

On the other hand, in a case where the secondary battery is continuously discharged from a time the full charge detecting portion detects that the secondary battery is brought into the full charge state until a time the discharge cut-off detecting portion detects that the secondary battery is brought into the discharge cut-off state, the cycle electric quantity setting portion sets, as the cycle electric quantity, the integrated electric quantity integrated by the current integrating portion from the time of the detection of the full charging state to the time of the detection of the discharging cut-off state, that is, the actual measured value of the battery capacity of the secondary battery. This can correct the cycle electric quantity to the actual battery capacity. As a result, it is possible to enhance the precision in the counting of the number of cycles in the cycle life.

Moreover, it is preferable to further include: a temperature detecting portion that detects a temperature of the secondary battery; and a decrement setting portion that sets the decrement to be increased in accordance with a change in the temperature detected by the temperature detecting portion in such a direction that the secondary battery is apt to be deteriorated due to the temperature.

Every time the secondary battery repeats the charging/discharging cycle, the full charging capacity is decreased due to deterioration. Furthermore, the secondary battery generally has a suitable temperature range for the charge/discharge, and has a property that deterioration caused by the charge/discharge is increased more, resulting in greater increase in a decrement of the capacity as farther away from the suitable temperature range, when the charge/discharge is performed out of the suitable temperature range.

According to the structure, therefore, a decrement to be used in the cycle electric quantity setting portion is set by the decrement setting portion so as to be increased more when the temperature of the secondary battery is apt to deteriorate the secondary battery more, that is, the decrement of the full charging capacity which is caused via the charging/discharging cycle is increased more. Consequently, the cycle electric quantity to be a reference for deciding a single cycle part in the cycle life can be approximated to the full charging capacity of the secondary battery in an actual temperature environment. As a result, it is possible to enhance the precision in the counting of the number of cycles.

In addition, it is preferable to further include: a charging control portion that controls the charge of the secondary battery in such a manner that a terminal voltage of the secondary battery does not exceed a predetermined set voltage; a deterioration degree acquiring portion that obtains a deterioration degree representing an extent of a deterioration in the secondary battery based on the number of cycles counted by the cycle counting portion; and a charging voltage setting portion that reduces the set voltage in accordance with an increase in the deterioration degree obtained by the deterioration degree acquiring portion.

According to the structure, the deterioration degree acquiring portion acquires the deterioration degree representing the extent of the deterioration of the secondary battery based on the number of cycles counted by the cycle counting portion. The charging voltage setting portion reduces the set voltage more as the deterioration degree is increased, and the charge of the secondary battery is controlled by the charging control portion in such a manner that the terminal voltage of the secondary battery does not exceed the set voltage. Consequently, the charging voltage of the secondary battery is controlled to be reduced more as the extent of the deterioration in the secondary battery is increased. As a result, the deterioration is advanced slowly. In addition, “the increase in the deterioration degree” means “the increase in the extent of the deterioration which is represented by the deterioration degree” and does not mean an increase in a numeric value of the deterioration degree which is indexed.

Moreover, it is preferable to further include a decrement setting portion that sets the decrement to be decreased in accordance with the reduction in the set voltage which is set by the charging voltage setting portion.

The decrement of the full charging electric quantity which is caused by the deterioration in the secondary battery is decreased as the charging voltage is dropped. According to the structure, as the voltage set by the charging voltage setting portion is dropped so that the charging voltage of the secondary battery is controlled to be reduced, there is decreased the decrement in the case in which the cycle electric quantity setting portion sets a new cycle electric quantity. Consequently, a deterioration reducing effect produced by the drop of the charging voltage is reflected on the cycle electric quantity. As a result, it is possible to enhance the precision in the counting of the number of cycles obtained by the cycle counting portion.

Furthermore, it is preferable to further include a temperature detecting portion that detects a temperature of the secondary battery, wherein the decrement setting portion sets the decrement to be decreased in accordance with the reduction in the set voltage which is set by the charging voltage setting portion and sets the decrement to be decreased in accordance with a change in the temperature detected by the temperature detecting portion in such a direction as to make the deterioration of the secondary battery difficult.

According to the structure, the decrement is decreased as the set voltage is dropped, that is, the charging voltage is dropped so that the deterioration in the secondary battery is reduced, and the decrement is decreased more when it is harder for the temperature of the secondary battery to deteriorate the secondary battery. Therefore, the influence of the deterioration caused by the charging voltage and the influence of the deterioration caused by the temperature are reflected on the decrement. As a result, it is possible to enhance the precision in the setting of the cycle electric quantity through the cycle electric quantity setting portion, and furthermore, to improve the precision in the counting of the number of cycles through the cycle counting portion.

Moreover, it is preferable that the deterioration degree acquiring portion includes: a cycle deterioration value calculating portion that calculates a cycle deterioration value representing an extent of a cycle deterioration by integrating a predetermined cycle addition value every time the number of cycles is updated by the cycle counting portion; a cycle addition value setting portion that sets the cycle addition value to be decreased in accordance with a reduction in the set voltage which is set by the charging voltage setting portion; and an acquiring portion that acquires the deterioration degree based on the cycle deterioration value calculated by the cycle deterioration value calculating portion.

According to the structure, every time one is added to the number of cycles by the cycle counting portion, a predetermined cycle addition value is integrated so that a cycle deterioration value representing an extent of a cycle deterioration is calculated by the cycle deterioration value calculating portion. In other words, the cycle addition value represents an extent of deterioration per cycle. When the set voltage is dropped, that is, the charging voltage is dropped so that the deterioration in the secondary battery is reduced more, the cycle addition value is decreased more by the cycle addition value setting portion. Therefore, the influence of the setting voltage on the deterioration caused in one cycle is reflected on the cycle addition value. As a result, precision in which the cycle addition value represents the extent of the deterioration per cycle can be enhanced so that precision in the deterioration indicated by the cycle deterioration value calculated by the cycle deterioration value calculating portion can be improved. As a result of the enhancement in the precision in the deterioration indicated by the cycle deterioration value, the precision in the deterioration degree which is acquired by the acquiring portion can be improved.

Moreover, a circuit for counting a number of cycles according to an aspect of the present invention includes: a cycle counting portion that counts a number of cycles in a cycle life of a secondary battery; a charging control portion that controls a charge of the secondary battery in such a manner that a terminal voltage of the secondary battery does not exceed a predetermined set voltage; a deterioration degree acquiring portion that obtains a deterioration degree representing an extent of a deterioration in the secondary battery based on the number of cycles counted by the cycle counting portion; and a charging voltage setting portion that reduces the set voltage in accordance with an increase in the deterioration degree acquired by the deterioration degree acquiring portion, wherein the deterioration degree acquiring portion includes: a cycle deterioration value calculating portion that calculates a cycle deterioration value representing an extent of a cycle deterioration by integrating predetermined cycle addition value every time the number of cycles is updated by the cycle counting portion; a cycle addition value setting portion that sets the cycle addition value to be decreased in accordance with a reduction in the set voltage which is set by the charging voltage setting portion; and an acquiring portion that acquires the deterioration degree based on the cycle deterioration value calculated by the cycle deterioration value calculating portion.

According to the structure, the deterioration degree representing the extent of the deterioration in the secondary battery is acquired by the deterioration degree acquiring portion based on the number of cycles counted by the cycle counting portion. The set voltage is reduced more with a greater increase in the deterioration degree by the charging voltage setting portion, and the charge of the secondary battery is controlled by the charging control portion in such a manner that the terminal voltage of the secondary battery does not exceed the set voltage. Consequently, the charging voltage of the secondary battery is controlled to be reduced as the extent of the deterioration in the secondary battery is increased. As a result, the deterioration is advanced slowly.

Every time the number of cycles is increased by the cycle counting portion, the predetermined cycle addition value is integrated so that the cycle deterioration value representing the extent of the cycle deterioration is calculated by the cycle deterioration value calculating portion. In other words, the cycle addition value represents the extent of the deterioration per cycle. When the set voltage is dropped, that is, the charging voltage is dropped so that the deterioration in the secondary battery is reduced more, the cycle addition value is decreased more by the cycle addition value setting portion. Therefore, the influence of the set voltage on the deterioration caused in one cycle is reflected on the cycle addition value. As a result, precision in which the cycle addition value represents the extent of the deterioration per cycle can be enhanced so that precision in the deterioration indicated by the cycle deterioration value calculated by the cycle deterioration value calculating portion can be improved. As a result of the enhancement in the precision in the deterioration indicated by the cycle deterioration value, the precision in the deterioration degree which is acquired by the acquiring portion can be improved. Consequently, it is possible to index the extent of the deterioration in the secondary battery with high precision and to represent the extent as the deterioration degree while making the deterioration in the secondary battery advancing slowly.

Furthermore, it is preferable to further include a temperature detecting portion that detects a temperature of the secondary battery, wherein the deterioration degree acquiring portion further includes: a storage deterioration value calculating portion that integrates predetermined storage deterioration addition values every unit time, thereby calculating a storage deterioration value representing an extent of a storage deterioration; and a storage deterioration addition value setting portion that sets the storage deterioration addition value to be increased in accordance with a change in the temperature detected by the temperature detecting portion in such a direction that the secondary battery is apt to be deteriorated due to the temperature, and wherein the acquiring portion calculates the deterioration degree based on the cycle deterioration value calculated by the cycle deterioration value calculating portion and the storage deterioration value calculated by the storage deterioration value calculating portion.

According to the structure, the influence of the temperature on deterioration in the storage which is caused in the storage state of the secondary battery is reflected so that the storage deterioration value is calculated. Therefore, it is possible to enhance precision in which the storage deterioration value indicates the extent of the storage deterioration. The deterioration degree to be acquired by the acquiring portion includes a cycle deterioration caused with the charging/discharging cycle and the storage deterioration caused in the storage state depending on a temperature environment and represents the extent of the deterioration in the secondary battery. Thus, it is possible to improve the extent of the deterioration which is represented by the deterioration degree.

Moreover, it is preferable to further include a life deciding portion that prohibits a charge of the secondary battery when the deterioration degree acquired by the deterioration degree acquiring portion exceeds a preset life decision level.

According to the structure, when it is supposed that the extent of the deterioration which is represented by the deterioration degree acquired by the deterioration degree acquiring portion exceeds the preset life decision level, that is, the secondary battery runs down, the charge of the secondary battery is prohibited. Therefore, it is possible to reduce a concern that the secondary battery running down might be charged, resulting in deterioration in a safety.

Moreover, a battery pack according to an aspect of the present invention includes the circuit for counting a number of cycles described above, and the secondary battery.

According to the structure, in the battery pack, it is possible to enhance the precision in the counting of the number of cycles in the cycle life also in the case in which the secondary battery is not charged into the full charging state or is not discharged into the discharging cut-off state.

Furthermore, a battery system according to the present invention includes: the circuit for counting a number of cycles described above; the secondary battery; a charging portion that supplies a charging current to the secondary battery; and a load circuit that is driven by a discharging current supplied from the secondary battery.

According to the structure, in a battery system for charging/discharging a secondary battery, it is possible to enhance the precision in the counting of the number of cycles in the cycle life also in the case in which the secondary battery is not charged into the full charging state or is not discharged into the discharging cut-off state.

In the circuit for counting number of cycles, the battery pack and the battery system including the same, it is possible to enhance the precision in the counting of the number of cycles in the cycle life also in the case in which the secondary battery is not charged into the full charging state or is not discharged into the discharging cut-off state.

The present application is based on Japanese Patent Application No. 2009-163624 filed on Jul. 10, 2009, and contents thereof are included in the present application.

The specific embodiments or examples made in the paragraph of the detailed description of the invention are to make the technical contents of the present invention apparent, and the present invention should not be construed to be restrictive to only the specific examples but various changes can be made within the spirit of the present invention and claims which will be described below.

### INDUSTRIAL APPLICABILITY

A circuit for counting number of cycles, and a battery pack and a battery system including the same according to the present invention can be suitably utilized in various apparatuses provided with a battery and systems, for example, an electronic apparatus such as a portable personal computer or digital camera or a portable telephone, a vehicle such as an electric car or a hybrid car, a power supply system obtained by a combination of a solar battery or a power generator and a secondary battery, and the like.

1. A circuit for counting a number of cycles comprising:
a current detecting portion that detects a current value of a current flowing to a secondary battery;
a current integrating portion that calculates, as an integrated electric quantity, an integrated value of the current value detected by the current detecting portion;
a cycle electric quantity setting portion that successively sets a cycle electric quantity corresponding to one cycle of a cycle life of the secondary battery; and
a cycle counting portion that counts a number of cycles of the cycle life, wherein
the current integrating portion includes:
a charging current integrating portion that integrates current values detected by the current detecting portion when the secondary battery is charged; and
a discharging current integrating portion that integrates current values detected by the current detecting portion when the secondary battery is discharged,
the cycle counting portion adds one to the last counted number of cycles when an increment of the integrated electric quantity calculated by one of the charging current integrating portion and the discharging current integrating portion after the number of cycles is counted last time reaches a last set cycle electric quantity, and
the cycle electric quantity setting portion decreases a predetermined decrement from the last set cycle electric quantity to set a new cycle electric quantity when the increment of the integrated electric quantity calculated by the other of the charging current integrating portion and the discharging current integrating portion after the number of cycles is counted last time reaches the last set cycle electric quantity.

2. The circuit for counting a number of cycles according to claim 1, wherein
the cycle counting portion adds one to the last counted number of cycles when the increment of the integrated electric quantity calculated by the charging current integrating portion after the number of cycles is counted last time reaches a last set cycle electric quantity, and
the cycle electric quantity setting portion decreases the decrement from the last set cycle electric quantity to set a new cycle electric quantity when the increment of the integrated electric quantity calculated by the discharging current integrating portion after the number of cycles is counted last time reaches the last set cycle electric quantity.

3. The circuit for counting a number of cycles according to claim 1, wherein
the cycle counting portion adds one to the last counted number of cycles when the increment of the integrated electric quantity calculated by the discharging current integrating portion after the number of cycles is counted last time reaches a last set cycle electric quantity, and
the cycle electric quantity setting portion decreases the decrement from the last set cycle electric quantity to set a new cycle electric quantity when the increment of the integrated electric quantity calculated by the charging current integrating portion after the number of cycles is counted last time reaches the last set cycle electric quantity.

4. (canceled)

5. The circuit for counting a number of cycles according to claim 1, wherein the cycle electric quantity setting portion sets a full charging capacity value in an initial condition of the secondary battery as an initial cycle electric quantity which is an initial value of the cycle electric quantity, and
the cycle counting portion adds one to the number of cycles when the integrated electric quantity calculated by the one of the charging current integrating portion and the discharging current integrating portion reaches the initial cycle electric quantity in an execution of first counting of the number of cycles.

6. (canceled)

7. The circuit for counting a number of cycles according to claim 1, further comprising a notifying portion that gives a notice of information about a life of the secondary battery corresponding to the number of cycles counted by the cycle counting portion.

8. The circuit for counting a number of cycles according to claim 1, further comprising:
a switching element that opens and closes a charge/discharge path to be charged/discharged by the secondary battery; and
a protection control portion that turns off the switching element when the number of cycles counted by the cycle counting portion is equal to or greater than the number of cycles indicating that the cycle life of the secondary battery has ended.

9. The circuit for counting a number of cycles according to claim 1, further comprising:
a discharge cut-off detecting portion that detects that the secondary battery is brought into a discharge cut-off state; and
a full charge detecting portion that detects that the secondary battery is brought into a full charge state, wherein
the cycle electric quantity setting portion further sets, in a case where the secondary battery is continuously charged from a time the discharge cut-off detecting portion detects that the secondary battery is brought into the discharge cut-off state until a time the full charge detecting portion detects that the secondary battery is brought into the full charge state, the integrated electric quantity integrated by the charging current integrating portion from the time the discharge cut-off state is detected until the time the full charge state is detected as the cycle electric quantity, and
sets, in a case where the secondary battery is continuously discharged from a time the full charge detecting portion detects that the secondary battery is brought into the full charge state until a time the discharge cut-off detecting portion detects that the secondary battery is brought into the discharge cut-off state, the integrated electric quantity integrated by the discharging current integrating portion from the time the full charge state is detected until the time the discharge cut-off state is detected as the cycle electric quantity.

10. The circuit for counting a number of cycles according to claim 1, further comprising:
a temperature detecting portion that detects a temperature of the secondary battery; and
a decrement setting portion that sets the decrement to be increased in accordance with a change in the temperature detected by the temperature detecting portion in such a direction that the secondary battery is apt to be deteriorated due to the temperature.

11. The circuit for counting a number of cycles according to claim 1, further comprising:
a charging control portion that controls the charge of the secondary battery in such a manner that a terminal voltage of the secondary battery does not exceed a predetermined set voltage;
a deterioration degree acquiring portion that obtains a deterioration degree representing an extent of a deterioration in the secondary battery based on the number of cycles counted by the cycle counting portion; and
a charging voltage setting portion that reduces the set voltage in accordance with an increase in the deterioration degree obtained by the deterioration degree acquiring portion.

12. The circuit for counting a number of cycles according to claim 11, further comprising a decrement setting portion that sets the decrement to be decreased in accordance with the reduction in the set voltage which is set by the charging voltage setting portion.

13. The circuit for counting a number of cycles according to claim 12, further comprising a temperature detecting portion that detects a temperature of the secondary battery, wherein
the decrement setting portion sets the decrement to be decreased in accordance with the reduction in the set voltage which is set by the charging voltage setting portion and sets the decrement to be decreased in accordance with a change in the temperature detected by the temperature detecting portion in such a direction as to make the deterioration of the secondary battery difficult.

14. The circuit for counting a number of cycles according to claim 11, wherein the deterioration degree acquiring portion includes:
a cycle deterioration value calculating portion that calculates a cycle deterioration value representing an extent of a cycle deterioration by integrating a predetermined cycle addition value every time the number of cycles is updated by the cycle counting portion;
a cycle addition value setting portion that sets the cycle addition value to be decreased in accordance with a reduction in the set voltage which is set by the charging voltage setting portion; and
an acquiring portion that acquires the deterioration degree based on the cycle deterioration value calculated by the cycle deterioration value calculating portion.

15. (canceled)

16. The circuit for counting a number of cycles according to claim 14, further comprising a temperature detecting portion that detects a temperature of the secondary battery, wherein the deterioration degree acquiring portion further includes:
a storage deterioration value calculating portion that integrates predetermined storage deterioration addition values every unit time, thereby calculating a storage deterioration value representing an extent of a storage deterioration; and
a storage deterioration addition value setting portion that sets the storage deterioration addition value to be increased in accordance with a change in the temperature detected by the temperature detecting portion in such a direction that the secondary battery is apt to be deteriorated due to the temperature, and
wherein the acquiring portion calculates the deterioration degree based on the cycle deterioration value calculated by the cycle deterioration value calculating portion and the storage deterioration value calculated by the storage deterioration value calculating portion.

17. The circuit for counting a number of cycles according to claim 11, further comprising a life deciding portion that prohibits a charge of the secondary battery when the deterioration degree acquired by the deterioration degree acquiring portion exceeds a preset life decision level.

18. A battery pack comprising the circuit for counting a number of cycles according to claim 1, and the secondary battery.

19. A battery system comprising:
the circuit for counting a number of cycles according to claim 1;
the secondary battery;
a charging portion that supplies a charging current to the secondary battery; and
a load circuit that is driven by a discharging current supplied from the secondary battery.
